(19) United States
(12) Patent Application Publication
(10) Pub. No.: US 2026/0199883 A1
(43) Pub. Date: Jul. 16, 2026

(54) METHODS FOR USE OF HIERARCHICALLY ORDERED CRYSTALLINE MICROPOROUS MATERIALS WITH LONG-RANGE MESOPOROUS ORDER

(71) Applicants: Saudi Arabian Oil Company, Dhahran (SA); King Abdullah University of Science and Technology, Thuwal (SA)

(72) Inventors: Robert Peter HODGKINS, Dhahran (SA); Guanghui ZHU, Dhahran (SA); Rajesh Kumar PARSAPUR, Thuwal (SA); Anissa Bendjeriou SEDJERARI, Thuwal (SA); Kuo-Wei HUANG, Thuwal (SA); Magnus RUEPING, Thuwal (SA)

(73) Assignees: Saudi Arabian Oil Company, Dhahran (SA); King Abdullah University of Science and Technology, Thuwal (SA)

(21) Appl. No.: 19/371,643

(22) Filed: Oct. 28, 2025

Related U.S. Application Data
(63) Continuation-in-part of application No. 19/296,083, filed on Aug. 11, 2025, now Pat. No. 12,616,965.
Application No. 19/296,083 is a continuation of application No. 18/151,892, filed on Jan. 9, 2023, now Pat. No. 12,409,445.
Application No. 18/151,892 is a continuation-in-part of application No. 17/857,447, filed on Jul. 5, 2022, now Pat. No. 12,152,204.
(63) Continuation-in-part of application No. 18/151,984, filed on Jan. 9, 2023.
Application No. 18/151,984 is a continuation-in-part of application No. 17/857,503, filed on Jul. 5, 2022, now Pat. No. 12,290,799.
(63) Continuation-in-part of application No. 19/178,255, filed on Apr. 14, 2025.
Application No. 19/178,255 is a division of application No. 17/857,572, filed on Jul. 5, 2022, now Pat. No. 12,338,130.
(63) Continuation-in-part of application No. 18/151,782, filed on Jan. 9, 2023.
Application No. 18/151,782 is a continuation-in-part of application No. 17/857,671, filed on Jul. 5, 2022, now Pat. No. 12,600,736.

(51) Int. Cl. B01J 29/08; B01J 21/04; B01J 23/881; C01B 39/02; C01B 39/24; C10G 47/20

(52) U.S. Cl. CPC B01J 29/084; B01J 21/04; B01J 23/881; C01B 39/026; C01B 39/24; C10G 47/20; C01P 2002/72; C01P 2002/76; C01P 2002/77; C01P 2002/88; C01P 2004/04; C10G 2300/1074

(57) ABSTRACT

Methods for use of hierarchically ordered FAU zeolites are provided. The hierarchically ordered FAU zeolites are used as hydrocracking catalysts, whereby middle distillate yields are enhanced. The catalysts herein possess a high-degree of well-defined long-range mesoporous ordering.

### RELATED APPLICATIONS

This application is:
a continuation-in-part of U.S. patent application Ser. No. 19/296,083 filed Aug. 11, 2025, which is a continuation of U.S. patent application Ser. No. 18/151,892, filed Jan. 9, 2023, now U.S. Pat. No. 12,409,445, which is a continuation-in-part of U.S. patent application Ser. No. 17/857,447 filed Jul. 5, 2022, now U.S. Pat. No. 12,152,204;
a continuation-in-part of U.S. patent application Ser. No. 18/151,984 filed Jan. 9, 2023, which is a continuation-in-part of U.S. patent application Ser. No. 17/857,503 filed Jul. 5, 2022, now U.S. Pat. No. 12,290,799;
a continuation-in-part of U.S. patent application Ser. No. 19/178,255 filed Apr. 14, 2025, which is a divisional of U.S. patent application Ser. No. 17/857,572 filed Jul. 5, 2022, now U.S. Pat. No. 12,338,130; and
a continuation-in-part of U.S. patent application Ser. No. 18/151,782 filed Jan. 9, 2023, which is a continuation-in-part of U.S. patent application Ser. No. 17/857,671 filed Jul. 5, 2022;
the contents all of which are incorporated herein by reference.

### FIELD OF THE DISCLOSURE

The present disclosure relates to methods for use of hierarchically ordered crystalline microporous materials.

### BACKGROUND OF THE DISCLOSURE

Zeolites are microporous aluminosilicate materials possessing well-defined structures and uniform pore sizes that can be measured in nanometers or angstroms (Å) (pores typically up to about 20 Å). Typically, zeolites comprise framework atoms such as silicon, aluminum and oxygen arranged as silica and alumina tetrahedra. Zeolites are generally hydrated aluminum silicates that can be made or selected with a controlled porosity and other characteristics, and typically contain cations, water and/or other molecules located in the porous network. Hundreds of natural and synthetic zeolite framework types exist with a wide range of applications. Numerous zeolites occur naturally and are extensively mined, whereas a wealth of interdependent research has resulted in an abundance of synthetic zeolites of different structures and compositions. The unique properties of zeolites and the ability to tailor zeolites for specific applications has resulted in the extensive use of zeolites in industry as catalysts (e.g., catalytic cracking of hydrocarbons or as components in catalytic convertors), molecular sieves, adsorbents (e.g., drying agents), ion exchange materials (e.g., water softening) and for the separation of gases. Certain types of zeolites find application in various processes in petroleum refineries and many other applications. The zeolite pores can form sites for catalytic reactions, and can also form channels that are selective for the passage of certain compounds and/or isomers to the exclusion of others. Zeolites can also possess an acidity level that enhances its efficacy as a catalytic material or adsorbent, alone or with the addition of active components. Described below is only one of the hundreds of types of zeolites that are identified by the International Zeolite Association (IZA). Properties and uses of many of these are well known.

Zeolite Y (also known as Na-Y zeolite or Y-type faujasite zeolite) is a well-known material for its zeolites have ion-exchange, catalytic and adsorptive properties. Zeolite Y is also a useful starting material for production of other zeolites such as ultra-stable y-type zeolite (USY). Like typical zeolites, faujasite is synthesized from alumina and silica sources, dissolved in a basic aqueous solution and crystallized. The faujasite zeolite has a framework designated as FAU by the IZA, and are formed by 12-ring structures having made of supercages with pore opening diameters of about 7.4 angstroms (Å) and sodalite cages with pore opening diameters of about 2.3 Å. Faujasite zeolites are characterized by a 3-dimensional pore structure with pores running perpendicular to each other in the x, y, and z planes. Secondary building units can be positioned at 4, 6, 6-2, 4-2, 1-4-4 or 6-6. An example silica-to-alumina ratio (SAR) range for faujasite zeolite is about 2 to about 6, typically with a unit cell size (units a, b and c) in the range of about 24.25 to 24.85 Å. Faujasite zeolites are typically considered X-type when the SAR is at about 2-3, and Y-type when the SAR is greater than about 3, for instance about 3-6. Typically, faujasite is in sodium form and can be ion exchanged with ammonium, and an ammonium form can be calcined to transform the zeolite to its proton form.

Whereas zeolites have found great utility in their ability to select between small molecules and different cations, mesoporous solids (pores between about 20 and 500 Å) offer possibilities for applications for species up to an order of magnitude larger in dimensions such as nanoparticles and enzymes. The comparatively bulky nature of such species hinders diffusion through the microporous zeolite network, and thus, a larger porous system is required to effectively perform an analogous molecular sieving action for the larger species.

Mesoporous silicas are amorphous; however, it is the pores that possess long-range order with a periodically aligned pore structure and uniform pore sizes on the mesoscale. Mesoporous silicas offer high surface areas and can be used as host materials to introduce additional functionality for a diverse range of applications such as adsorption, separation, catalysis, drug delivery and energy conversion and storage.

An attractive property of ordered structures is that their architecture may be described in relation to their symmetry. The regular form of crystals is associated with the regular arrangements of the sub-units comprising the crystal, and hence, the symmetry of the crystal is connected to the symmetry of the sub-units. For example, seven distinct three-dimensional crystal units are provided in Table 1. The crystal systems can be sub-divided upon the symmetry elements present, collectively referred to as the point group and provided in Table 2. For example, 3m infers that a mirror plane having a three-fold axis is present. For the class 3/m (or 6) the mirror plane is perpendicular to the three-fold axis. In 2D space, such as a lamellar system, having fewer dimensions than 3D, there are four crystal systems: hexagonal, square, rectangular and oblique.

The well-defined microporous structure of zeolites provides an amalgam of important physicochemical functionalities that are highly desirable in various industrial practices. Their molecular-sized pore channels embedded with tunable acid/base sites can geometrically discriminate the ingress of guest species and direct shape-selective transformations. Such remarkable properties uniquely exhibited by zeolites demonstrate unprecedented importance in numerous chemical technologies, including but not limited to oil-refining, detergents and effluent abatement, that profoundly impact the global economy and environment. However, zeolite performance is often hindered as a result of their poor mass-transfer abilities induced by configurational diffusion inside the narrow micropores. Therefore, mitigation of the intrinsic mass-transfer limitations is important to explore the full potential of zeolites in diverse energy economies and thereby enhance the accessibility to internal functional sites. Other drawbacks of microporous zeolites as catalysts in certain reactions are their susceptibility to coking, which can lead to accelerated deactivation of catalysts and product selectivity.

In this regard, hierarchically ordered zeolites (HOZs) possessing an ordered mesoporous structure and zeolitized mesopore walls are of great technological importance due to their exceptional properties. HOZs contain different layers of porosity, that is, mesopores and micropores. Hierarchically ordered zeolites offer advantages over traditional microporous zeolites by, for example, improving diffusion of guest species to the active sites, overcoming steric limitations, improving product selectivity, decreasing coke formation, improving hydrothermal stability, and improving accessibility of Bronsted acid sites and Lewis acid sites; and concomitantly, improved catalytic performance.

Numerous synthetic strategies to produce hierarchical zeolites are known, and fall under two general categories: bottom-up approaches which include the use of hard templates and soft templates, and top-down approaches which typically involve post-synthetic treatment. Bottom-up strategies generally involve templating techniques used in situ during zeolite crystallization, for example using hard templates (carbon sources) or soft templates (surfactants). Top-down strategies generally involve post-synthetic modifications of already formed zeolite crystals, for example, by steaming, dealumination (using an acid) or desilication (using a base). Weaknesses of known processes to produce hierarchically ordered zeolites is that the long-rage ordering of the mesophase in the resulting zeolite is limited or non-existent, and mesopores can be random in size, location and ordering.

Base-mediated desilication offers a direct route to creating mesoporosity in high-silica frameworks obtained from steaming. (see, e.g.: Verboekend, D., Milina, M., Mitchell, S. & Perez-Ramirez, J. Hierarchical Zeolites by Desilication: Occurrence and Catalytic Impact of Recrystallization and Restructuring. Crys. Growth Des. 13, 5025-5035(2013)). In particular, integrating organic templates during the desilication process has significantly improved crystallinity and mesoporosity. (see, e.g.: García-Martínez, J., Johnson, M., Valla, J., Li, K. & Ying, J. Y. Mesostructured Zeolite Y—High Hydrothermal Stability and Superior FCC Catalytic Performance. Catal. Sci. Tech. 2, 987 (2012); Mendoza-Castro, M. J., Serrano, E., Linares, N. & García-Martínez, J. Surfactant-Templated Zeolites: From Thermodynamics to Direct Observation. Adv. Mater. Interfaces 8, 2001388 (2020)). However, such post-synthetic modification strategies typically lack control over the dissolution and self-assembly process, resulting in poorly interconnected mesopores. (see, e.g.: Schwieger, W. et al. Hierarchy Concepts: Classification and Preparation Strategies for Zeolite Containing Materials with Hierarchical Porosity. Chem. Soc. Rev. 45, 3353-3376, doi:10.1039/c5cs00599j (2016)).

In view of the prior attempts to produce hierarchically ordered zeolites, there remains a need in the art for improved synthesis methods. It is in regard to these and other problems in the art that the present disclosure is directed to provide a technical solution for an effective method to synthesize and produce hierarchically ordered zeolites having well-defined long-range mesoporous ordering.

### SUMMARY OF THE DISCLOSURE

A hydrocracking method is provided. In some embodiments, the hydrocracking method comprises contacting a hydrocarbon feed with one or more hierarchically ordered FAU zeolite catalysts, an inorganic oxide, an active metal component, and hydrogen in a hydrocracking reactor to produce a hydrocracked effluent. The one or more hierarchically ordered FAU zeolite catalysts have a high-degree of long-range mesoporous ordering. The one or more hierarchically ordered FAU zeolite catalysts possess a cubic mesophase symmetry or possess a hexagonal mesophase symmetry.

In some embodiments, the one or more hierarchically ordered FAU zeolite catalysts have a mesopore periodicity repeating over a length of greater than about 50 nm. The long-range mesoporous ordering of the one or more hierarchically ordered FAU zeolite catalysts is defined by the presence of secondary peaks in an X-ray diffraction (XRD) pattern. The hydrocarbon feed is selected from the group consisting of refined oil obtained from crude oil, synthetic crude oil, bitumen, oil sand, shale oil, and coal oil. The hydrocarbon feed has a nitrogen content of less than or equal to 50 ppm and a boiling point of less than or equal to 833° C. The one or more hierarchically ordered FAU zeolite catalysts are passivated.

In some embodiments, the wherein hydrocracking reactor operates at a temperature in the range of from 300° C. to 500° C., a hydrogen partial pressure in the range of from 3.5 MPa to 35 MPa, a hydrogen-to-oil ratio in the range of from 500 N·m/m³ to 2500 N·m/m³, and a liquid hourly space velocity (LHSV) in the range of from 0.1 hr⁻¹ to 10 hr⁻¹. The the one or more hierarchically ordered FAU zeolite catalysts has a total acidity in the range of from 0.05-0.5 mmol/g.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

The process of the disclosure will be described in more detail below and with reference to the attached drawings in which the same number is used for the same or similar elements.

FIGS. 1 and 2 are schematic overviews of hierarchical ordering by post-synthetic ensembles synthesis route described herein.

FIG. 3A depicts low-angle XRD, and FIG. 3B depicts high-angle XRD patterns, associated with products synthesized in Examples 1A-1C.

FIG. 4A depicts N₂ physisorption isotherms, and FIG. 4B depicts NLDFT pore-size distributions, associated with products synthesized in Examples 1A-1C.

FIGS. 5A-5C depict TEM micrographs of hierarchically ordered zeolite synthesized in Example 1B.

FIG. 6 depicts SEM images of products synthesized in Examples 1A-1C.

FIG. 7A depicts low-angle XRD, and FIG. 7B depicts high-angle XRD patterns, associated with products synthesized in Examples 2A-2B.

FIG. 8A depicts N₂ physisorption isotherms, and FIG. 8B depicts NLDFT pore-size distributions, associated with products synthesized in Example 2A-2B.

FIGS. 9A-9C depict TEM micrographs of hierarchically ordered zeolite synthesized in Example 2A.

FIGS. 10A-10B depict TEM micrographs of hierarchically ordered zeolite synthesized in Example 2A, and FIG. 10C depicts unit cell schematic and dimensions for parent zeolite.

FIG. 11 depicts electron tomography reconstruction of hierarchically ordered zeolite synthesized in Example 2B.

FIGS. 12A-12C depict TEM micrographs of hierarchically ordered zeolite synthesized in Example 2B.

FIGS. 13A and 13B depict low-angle XRD, and FIGS. 13C and 13D depict high-angle XRD patterns, associated with products synthesized in Examples 3A-3B.

FIGS. 14A and 14C depict N₂ physisorption isotherms, and FIGS. 14B and 14D depict NLDFT pore-size distributions, associated with products synthesized in Example 3A-3B.

FIGS. 15A-15E depict TEM micrographs of hierarchically ordered zeolite synthesized in Example 3A.

FIG. 16A depicts low-angle XRD, and FIG. 16B depicts high-angle XRD patterns associated with calcined products from Example 4A.

FIG. 17A depicts N₂ physisorption isotherms, and FIG. 17B depicts NLDFT pore-size distributions, associated with products synthesized in Example 4A.

FIG. 18 depicts FTIR spectra characterizing acid sites of certain examples herein.

FIGS. 19A-19B depict NMR spectra characterizing certain examples herein.

FIG. 20A depicts high-angle XRD patterns of the parent zeolite treated with NH₄OH and urea, FIG. 20B depicts the parent zeolite treated with urea over time, FIGS. 20C-20D depict NMR spectra of the parent zeolite treated with NH₄OH and urea, and FIG. 20E is a schematic a schematic of zeolitic fragments from urea dissolution.

FIG. 21 depicts a plot of the change in middle distillate yield as a function of normalized acidity.

FIGS. 22A and 22B are plots of hydrocracking activity (conversion percentage per acid site) and selectivity (naphtha, middle distillates and heavy distillates) of synthesized materials in examples herein, and a parent zeolite.

### DETAILED DESCRIPTION OF CERTAIN EMBODIMENTS OF THE DISCLOSURE

Methods for producing hydrocracking catalysts, or components of catalysts, including hierarchically ordered zeolites and zeolite-type materials (hereinafter “crystalline microporous material” or “CMM,” used in singular or plural forms as appropriate) are provided. Synthesized hierarchically ordered crystalline microporous materials (“HOCMM” used in singular or plural forms as appropriate) possess a high-degree of well-defined long-range mesoporous ordering. Method of producing the HOCMMs described herein are disclosed in co-pending and commonly owned U.S. patent application Ser. No. 17/857,671 filed on Jul. 5, 2022. Synthesizing HOCMMs in the process herein overcomes problems associated with known methods by using by base-mediated reassembly, by dissolution of the parent CMM to the level of structural building units that are oligomers of the parent CMM, and minimizing or avoiding amorphization/structural collapse. The CMM dissolution and self-assembly is comprehensively controlled to produce HOCMMs according to the methods herein. Compositions formed according to these methods are disclosed in commonly owned U.S. patent Ser. No. 12/152,204 issued on Nov. 26, 2024 entitled “Hierarchically Ordered Crystalline Microporous Materials with Long-Range Mesoporous Order Having Cubic Symmetry”; and Ser. No. 12/290,799 issued on May 6, 2025 entitled “Hierarchically Ordered Crystalline Microporous Materials with Long-Range Mesoporous Order Having Hexagonal Symmetry”.

CMM of the HOCMM comprises FAU zeolites. The hierarchically ordered FAU zeolites produced according to the present disclosure are effective as catalysts, or components of catalysts, in hydrocracking of hydrocarbon oil. In some embodiments, the hierarchically ordered FAU zeolites can be used as a support having loaded thereon one or more active metal components as a hydrocracking catalyst. The active metal components are loaded, for example, carried on surfaces including the mesopore wall surfaces, micropore wall surfaces or mesopore and micropore wall surfaces; the active metal components are loaded according to known methods, such as providing an aqueous solution of the active metal components and subjecting hierarchically ordered FAU zeolites as catalyst support material to immersion, incipient wetness, and evaporative, or any other suitable method. In some embodiments, the support can comprise the FAU zeolite and a binder.

The content of the hierarchically ordered FAU zeolites and the active metal component are appropriately determined according to the object. In certain embodiments, a hydrocracking catalyst comprises as a support the hierarchically ordered FAU zeolites and an inorganic oxide component, typically as a binder and/or granulating agent. For example, support particles (prior to loading of one or more hydrocracking active metal components) can contain hierarchically ordered FAU zeolites in the range of about 0.1-99, 0.1-90, 0.1-80, 0.1-70, 0.1-50, 0.1-40, 2-99, 2-90, 2-80, 2-70, 2-50, 2-40, 20-100, 20-90, 20-80, 20-70, 20-50, or 20-40 wt %, with the remaining content being the inorganic oxide. In certain embodiments, support particles (prior to loading of one or more hydrocracking active metal components) can contain hierarchically ordered FAU zeolites in the range of about 0.1-99, 0.1-90, 0.1-80, 0.1-70, 0.1-50, 0.1-40, 2-99, 2-90, 2-80, 2-70, 2-50, 2-40, 20-100, 20-90, 20-80, 20-70, 20-50, or 20-40 wt %, with the remaining content being the inorganic oxide and one or more other zeolitic materials.

In certain embodiments, a hydrocracking catalyst is provided comprising the hierarchically ordered zeolite described herein, an inorganic oxide component as a binder, and an active metal component. For example, the hierarchically ordered crystalline microporous material comprises about 0.1-99, 0.1-90, 0.1-80, 0.1-70, 0.1-50, 0.1-40, 2-99, 2-90, 2-80, 2-70, 2-50, 2-40, 20-100, 20-90, 20-80, 20-70, 20-50, or 20-40 wt % of the hydrocracking catalyst.

As the inorganic oxide component, any material used in hydrocracking or other catalyst compositions in the related art can be used. Examples thereof include alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, silica-alumina-zirconia, alumina-zirconia-titania, phosphorous-alumina-zirconia, alumina-zirconia-titania and phosphorus-alumina-titania.

The active metal component can include one or more metals or metal compounds (oxides or sulfides) known in the art of hydrocracking, including those selected from the Periodic Table of the Elements IUPAC Groups 6, 7, 8, 9 and 10. In certain embodiments the active metal component is one or more of Mo, W, Co or Ni (oxides or sulfides). The additional active metal component may be contained in catalyst in effective concentrations. For example, total active component content in hydrocracking catalysts can be present in an amount as is known in the related art, for example about 0.01-40, 0.1-40, 1-40, 2-40, 5-40, 0.01-30, 0.1-30, 1-30, 2-30, 5-30, 0.01-20, 0.1-20, 1-20, 2-20 or 5-20 W % in terms of metal, oxide or sulfide. In certain embodiments, active metal components are loaded using a solution of salts, converted to oxides after calcination, and prior to use, the hydrocracking catalysts are sulfided.

In certain embodiments, a method for hydrocracking hydrocarbon oil is provided, comprising hydrocracking hydrocarbon oil with a hydrocracking catalyst including the hierarchically ordered zeolite described herein. In certain embodiments, the hydrocarbon oil comprises a recycle stream obtained from hydrocracking of VGO, straight run VGO or pre-treated straight run VGO, with selectivity to middle distillates tailored as a function of the cubic and hexagonal symmetry mesophase.

Hierarchically ordered FAU zeolites produced according to the present disclosure are effective as catalysts, or components of catalysts, in hydrocracking of hydrocarbon oil. In certain embodiments, a method for hydrocracking hydrocarbon oil is provided herein, including hydrocracking hydrocarbon oil with a hydrocracking catalyst including hierarchically ordered zeolite produced according to the present disclosure. In certain embodiments, a method for hydrocracking hydrocarbon oil is provided herein, including hydrocracking hydrocarbon oil with a hydrocracking catalyst including hierarchically ordered FAU zeolite produced according to the present disclosure. In certain embodiments, a method for hydrocracking hydrocarbon oil is provided herein, including hydrocracking hydrocarbon oil with a hydrocracking catalyst including hierarchically ordered crystalline microporous material having well-defined long-range mesoporous ordering of cubic or hexagonal symmetry comprising mesopores having walls of crystalline microporous material and a mass of mesostructure between mesopores of crystalline microporous material.

Hierarchically ordered FAU zeolites according to the present disclosure are effective as catalysts, or components of catalysts, in hydrocracking of hydrocarbon oil. The hierarchically ordered FAU zeolites can be used as a support having loaded thereon one or more active metal components as a hydrocracking catalyst. The active metal components are loaded, for example, carried on surfaces including the mesopore wall surfaces, micropore wall surfaces or mesopore and micropore wall surfaces; the active metal components are loaded according to known methods, such as providing an aqueous solution of the active metal components and subjecting hierarchically ordered FAU zeolite as catalyst support material to immersion, incipient wetness, and evaporative, or any other suitable method.

The content of the hierarchically ordered FAU zeolites and the active metal component are appropriately determined according to the object. In certain embodiments, a hydrocracking catalyst comprises as a support the hierarchically ordered FAU zeolites and an inorganic oxide component, typically as a binder and/or granulating agent. For example, support particles (prior to loading of one or more hydrocracking active metal components) can contain hierarchically ordered FAU zeolites in the range of about 0.1-99, 0.1-90, 0.1-80, 0.1-70, 0.1-50, 0.1-40, 2-99, 2-90, 2-80, 2-70, 2-50, 2-40, 20-100, 20-90, 20-80, 20-70, 20-50, or 20-40 wt %, with the remaining content being the inorganic oxide. In certain embodiments, support particles (prior to loading of one or more hydrocracking active metal components) can contain hierarchically ordered FAU zeolites in the range of about 0.1-99, 0.1-90, 0.1-80, 0.1-70, 0.1-50, 0.1-40, 2-99, 2-90, 2-80, 2-70, 2-50, 2-40, 20-100, 20-90, 20-80, 20-70, 20-50, or 20-40 wt %, with the remaining content being the inorganic oxide and one or more other zeolitic materials.

As the inorganic oxide component, any material used in hydrocracking or other catalyst compositions in the related art can be used. Examples thereof include alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, silica-alumina-zirconia, alumina-zirconia-titania, phosphorous-alumina-zirconia, alumina-zirconia-titania and phosphorus-alumina-titania.

The active metal component can include one or more metals or metal compounds (oxides or sulfides) known in the art of hydrocracking, including those selected from the Periodic Table of the Elements IUPAC Groups 6, 7, 8, 9 and 10. In certain embodiments the active metal component is one or more of Mo, W, Co or Ni (oxides or sulfides). The additional active metal component may be contained in catalyst in effective concentrations. For example, total active component content in hydrocracking catalysts can be present in an amount as is known in the related art, for example about 0.01-40, 0.1-40, 1-40, 2-40, 5-40, 0.01-30, 0.1-30, 1-30, 2-30, 5-30, 0.01-20, 0.1-20, 1-20, 2-20 or 5-20 W % in terms of metal, oxide or sulfide. In certain embodiments, active metal components are loaded using a solution of salts, converted to oxides after calcination, and prior to use, the hydrocracking catalysts are sulfided.

In certain embodiments, a method for hydrocracking hydrocarbon oil using a hydrocracking catalyst described herein including hierarchically ordered FAU zeolite as a component comprises introducing a hydrocarbon oil, for instance having a boiling point in the range of about 370-833, 370-816, 370-650, 375-833, 375-816 or 375-650° C., in the presence of hydrogen, to a hydrocracking zone including one or more reactors operating at a reactor temperature in the range of about 300-500, 300-450, 300-420, 350-500, 350-450 or 350-420° C., a hydrogen partial pressure in the range of about 20-100, 20-70, 20-55, 30-100, 30-70, 30-55 or 40-55 bar, a liquid hourly space velocity (“LHSV”, which refers to the volumetric flow rate of the liquid feed divided by the volume of the catalyst) in the range of about 0.1-10, 0.2-1.5 h⁻¹, and a hydrogen/oil ratio of in the range of about 500-2,500, 1,000-2,000 normalized cubic meters of hydrogen per cubic meter of oil (Nm³/m³). “Hydrocracking zone” means one or more reactors and associated effluent separation apparatus, and can contain two or more reactors. In certain embodiments, the feed is pre-treated, or is a recycle stream, within the boiling point ranges described above, with sulfur content of less than 100 ppmw or 50 ppmw or 10 ppmw, and nitrogen content of less than 100 ppmw or 50 ppmw or 10 ppmw.

In a method for hydrocracking hydrocarbon oil according to certain embodiments herein, the flow reactor described above can be a flow reactor selected from a stirring bath type reactor, a boiling bed type reactor, a baffle-equipped slurry bath type reactor, a fixed bed type reactor, a rotary tube type reactor and a slurry bed type reactor.

In a method for hydrocracking hydrocarbon oil according to certain embodiments herein, the hydrocarbon oil described above contains heavy hydrocarbon oil obtained from crude oil, synthetic crude oil, bitumen, oil sand, shell oil or coal liquid, and the above heavy hydrocarbon oil is preferably any of a) vacuum gas oil (VGO), b) deasphalted oil (DAO) obtained from a solvent deasphalting process or demetallized oil, c) light coker gas oil or heavy coker gas oil obtained from a coker process, d) cycle oil obtained from a fluid catalytic cracking (FCC) process e) gas oil obtained from a visbreaking process, or f) a recycle stream obtained from hydrocracking of one or more of (a)-(e). In a method for hydrocracking hydrocarbon oil according to certain embodiments herein, the hydrocarbon oil comprises a recycle stream obtained from hydrocracking of VGO. In a method for hydrocracking hydrocarbon oil using a hydrocracking catalyst described herein including hierarchically ordered FAU zeolites as a component according to certain embodiments herein, the hydrocarbon oil comprises a recycle stream obtained from hydrocracking of VGO, straight run VGO or pre-treated straight run VGO, with selectivity to naphtha and/or middle distillates tailored as a function of the mesophase induced in the hierarchically ordered FAU zeolites described herein to allow operation flexibility. In a method for hydrocracking hydrocarbon oil using a hydrocracking catalyst described herein including hierarchically ordered FAU zeolites as a component according to certain embodiments herein, the hydrocarbon oil comprises a recycle stream obtained from hydrocracking of VGO, straight run VGO or pre-treated straight run VGO, with selectivity to naphtha and/or middle distillates tailored as a function of the mesophase induced in the hierarchically ordered FAU zeolites described herein to allow operation flexibility.

In a method for hydrocracking hydrocarbon oil using a hydrocracking catalyst described herein including hierarchically ordered FAU zeolites as a component according to certain embodiments herein, the hydrocarbon oil comprises a recycle stream obtained from hydrocracking of VGO, straight run VGO or pre-treated straight run VGO, with selectivity to naphtha and middle distillates tailored as a function of the cubic and hexagonal symmetry mesophase induced in the hierarchically ordered FAU zeolites described herein to allow operation flexibility.

In some embodiments the hierarchically ordered FAU zeolites can be used as a component to hydrocrack hydrocarbon oil. In a method for hydrocracking hydrocarbon oil according to certain embodiments herein, the hydrocarbon oil described above contains preferably heavy hydrocarbon oil obtained from (1) crude oil, (2) synthetic crude oil, (3) bitumen, (4) oil sand, (5) shale oil, (6) coal liquid (7) plastic pyrolysis oils, (8) biomass derived oils or (9) Fisher-Tropsch wax.

In some embodiments, the total acidity of the hierarchical zeolite having long range mesoporous ordering is in the range of from 0.05-0.5, 0.05-0.3, 0.05-0.1, 0.1-0.5, 0.1-3, or 3-5 mmol/g.

In some embodiments, the hierarchically ordered FAU zeolites-containing hydrocracking catalyst is passivated, for example, with ammonia.

In certain embodiments of reassembly: the rate and extent of FAU zeolites dissolution is controlled by employing urea as an in situ base, and by mediating hydrothermal temperature to control urea hydrolysis and fine-tune pH of the solution; extent of dissolution into smaller oligomers is controlled by the surfactant-FAU zeolites interactions during the initial stages of dissolution, whereby influence of the ion-specific interactions, that is, anionic Hofmeister effect (AHE) on supramolecular self-assembly directs formation of hierarchically ordered structures with hexagonal mesopore symmetry, bicontinuous gyroid cubic mesopore symmetry; in certain embodiments the hierarchically ordered structures possess hexagonal p6 mm mesopore symmetry and bicontinuous gyroid cubic Ia-3d mesopore symmetry.

According to an embodiment of the method, a parent FAU zeolite is formed into an aqueous suspension with an alkaline reagent and a supramolecular templating agent. In additional embodiments, the aqueous suspension includes an ionic co-solute as an additional anion that is separate from the anion which is paired with the cation of the supramolecular template. The system is maintained under conditions to induce incision of the parent FAU zeolite into oligomeric units of the FAU zeolite, with only a minor portion of monomeric units, and to induce hierarchical reassembly of the oligomeric units into mesostructures. System conditions (including temperature and time of crystallization), selection and concentration of supramolecular template, and selection and concentration of alkaline reagent are tailored to control incision of the parent FAU zeolite into oligomeric units and to control reassembly of those oligomeric units around the shape(s) of supramolecular template micelles. Dissolution of parent FAU zeolite is encouraged to the extent of oligomer formation while minimizing monomer formation, which is controlled by selection of supramolecular template, alkaline reagent, optional ionic co-solute and hydrothermal conditions (including temperature and time). In certain embodiments, a substantial portion, a significant portion or a major portion of the parent FAU zeolite is cleaved into oligomeric units, with any remainder in the form of monomeric units or atomic constituents of the FAU zeolite. In certain embodiments, dimensions of the oligomeric units correspond approximately to the wall thickness of the synthesized mesoporous structure, the hierarchically ordered FAU zeolites. In certain embodiments interface curvature(s) of the micelles and oligomeric units under reassembly is tuned to a desired mesostructure and mesoporosity with the aid of optional ionic co-solute and the Hofmeister effect.

Under effective crystallization conditions and time, and using effective type(s) of supramolecular template and alkaline reagent at effective relative concentrations, hierarchical ordering by post-synthetic ensembles occurs: the parent FAU zeolite is incised into oligomeric FAU zeolite units that rearrange around the shaped micelles formed by the supramolecular templates. Hierarchically ordered FAU zeolites having well-defined long-range mesoporous ordering are formed by the supramolecular templating method using the surfactant micelles. The mesopore walls are characterized by the parent FAU zeolite. The effective supramolecular templates include those having one or more properties forming a dimension that blocks all, a substantial portion, a significant portion or a major portion of the supramolecular template molecules from entering pores, channels and/or cavities of the parent FAU zeolite. These methods disclosed herein effectuate base-mediated incisions of the FAU zeolite crystals, in the presence of the supramolecular template of the type/characteristic disclosed herein, into oligomeric components, with subsequent reorganization around well-defined micelles by supramolecular templating, into hierarchically ordered structures having a well-defined long-range mesoporous ordering.

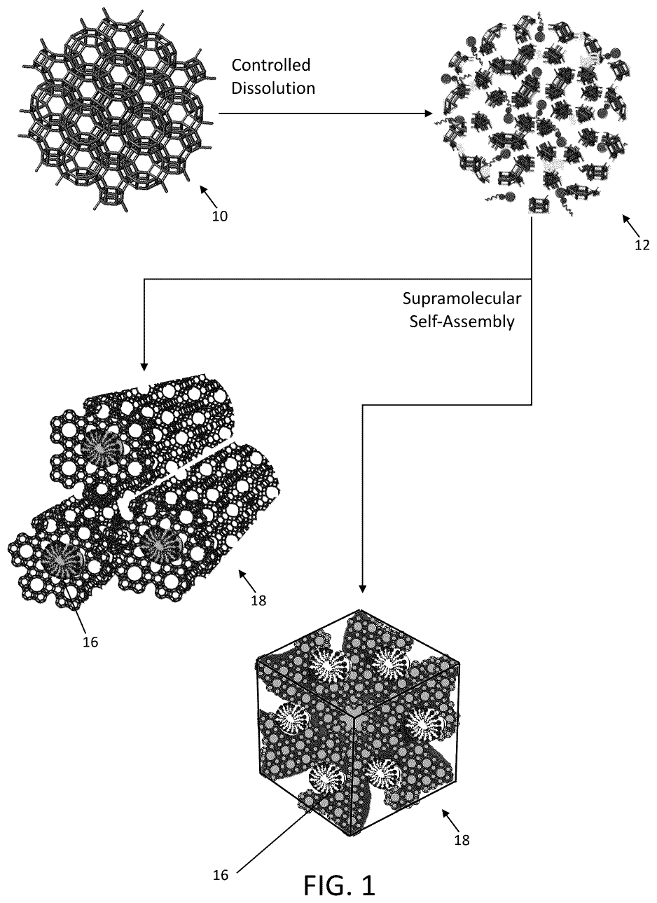

The curvature or shape of the micelles results in the final mesophase symmetry, for example, hexagonal or cubic. Formation of the supramolecular template molecules into micelles is dependent upon factors such as the supramolecular template type, supramolecular template concentration, presence or absence of an ionic co-solute, FAU zeolite type(s), crystallization temperature, type of alkaline reagent, concentration of alkaline reagent, pH level of the system, and/or presence or absence of other reagents. In general, at low concentrations supramolecular templates exist as discrete entities. At higher concentrations, that is, above a critical micelle concentration (CMC), micelles are formed. The hydrophobic interactions in the system including the supramolecular template alters the packing shape of the supramolecular templates into, for example, spherical, prolate or cylindrical micelles, which can thereafter form thermodynamically stable two-dimensional or three-dimensional liquid crystalline phases of ordered mesostructures (see, for example, FIG. 1.4 of Zana, R. (Ed.). (2005). Dynamics of Surfactant Self-Assemblies: Micelles, Microemulsions, Vesicles and Lyotropic Phases (1^{st} ed.). CRC Press, Chapter 1, which shows self-assembly based on surfactant and surfactant packing parameter).

In certain embodiments, the Hofmeister series (HS), ion specific effect, or lyotropic sequence is followed for selection of supramolecular templates and/or ionic co-solute to control curvature or shape (e.g., spherical, ellipsoid, cylindrical, or unilamellar structures) of the micelles (see, for example, Beibei Kang, Huicheng Tang, Zengdian Zhao, and Shasha Song. “Hofmeister Series: Insights of Ion Specificity from Amphiphilic Assembly and Interface Property” ACS Omega 5 (2020): 6229-6239). In embodiments of the methods for synthesis of hierarchically ordered microporous crystalline materials having well-defined long-range mesoporous ordering disclosed herein, mesophase transitions of hierarchical ensembles yield distinct mesostructures based on the anionic Hofmeister effect and supramolecular self-assembly. Anions of different sizes and charges possess different polarizabilities, charge densities and hydration energies in aqueous solutions. When paired with a positive supramolecular template head group, these properties can affect the short-range electrostatic repulsions among the head groups and hydration at the micellar interface, thus changing the area of the head group (a₀). Such ion-specific interactions can be a driving force in changing the micellar curvature and inducing mesophase transition. Based on the HS (SO₄²⁻>HPO₄²⁻>Oac⁻>Cl⁻>Br⁻>NO₃⁻>ClO₄⁻>SCN⁻), strongly hydrated ions (left side of the HS) can increase the micellar curvature, whereas weakly hydrated ions can decrease the micellar curvature. A surfactant packing parameter, g=V/a₀l (V=total volume of surfactant tails, a₀=area of the head group, l=length of surfactant tail), can be used to describe these mesophase transitions.

In the methods for synthesis of hierarchically ordered FAU zeolites having well-defined long-range mesoporous ordering disclosed herein, suitable alkaline reagents include one or more basic compounds to maintain the system at a pH level of greater than about 8. In certain embodiments the alkaline reagent is provided at a concentration in the aqueous suspension of about 0.1-2.0 M. In certain embodiments the alkaline reagent is provided at a concentration in the aqueous suspension of about 0.1-5 wt %. In certain embodiments the alkaline reagent comprises urea. In certain embodiments the alkaline reagent comprises ammonia. In certain embodiments the alkaline reagent comprises ammonium hydroxide. In certain embodiments the alkaline reagent comprises sodium hydroxide. In certain embodiments the alkaline reagent comprises alkali metal hydroxides including hydroxides of sodium, lithium, potassium, rubidium, or cesium.

In certain embodiments the alkaline reagent is effective to enable controlled hydrolysis; for example, urea can be used as an alkaline agent, and during hydrolysis urea reacts to form ammonium hydroxide. For example, higher urea concentration can be used in the initial step, and basicity can be maintained by gradual urea hydrolysis. In such embodiments, pH is increased relatively slowly to a maximum pH as a function of time, which is beneficial to the process, rather than adding an amount of another alkaline reagent such as ammonium hydroxide in the initial solution to the maximum pH. Unlike conventional bases, which act swiftly, urea is pH neutral at ambient conditions and can disperse uniformly throughout the zeolitic micropores without affecting them.

In certain embodiments the alkaline reagent comprises alkylammonium cations, having the general formula R_{X}H_{4-X}N⁺[A⁻], wherein at X=1-4 and R₁, R₂, R₃ and R₄ can be the same or different C1-C30 alkyl groups, and wherein [A⁻] is a counter anion can be OH⁻, Br⁻, Cl⁻ or I⁻. In certain embodiments the alkaline reagent comprises quaternary ammonium cations with alkoxysilyl groups, phosphonium groups, an alkyl group with a bulkier substituent or an alkoxyl group with a bulkier substituent. In certain embodiments the alkylammonium cations used in this regard function as a base rather than as a surfactant or template.

In certain embodiments using ammonia, ammonium hydroxide or alkali metal hydroxides, amorphous material is also present with the crystalline material in the product. In certain embodiments, upon calcining the as-made hierarchically ordered FAU zeolites there is a reduction in the amount of apparent amorphous material present (for example an overall broad band at 25° (2θ) in XRD), indicative of apparent “self-healing” after calcination. In certain embodiments, by the controlled hydrolysis of urea to ammonium hydroxide there is a reduction in the amount of apparent amorphous material present in the hierarchically ordered FAU zeolites (for example an overall broad band at 25° (2θ) in XRD), when compared with alternative routes such as NaOH or directly with ammonium hydroxide.

In the methods for synthesis of hierarchically ordered FAU zeolites having well-defined long-range mesoporous ordering disclosed herein, suitable surfactants as supramolecular templates are provided to assist the reassembly and recrystallization of dissolved components (oligomers) by covalent and/or electrovalent interactions. Supramolecular templates are provided at a concentration in the aqueous suspension of about 0.01-0.5 M. In certain embodiments suitable supramolecular templates are provided at a concentration in the aqueous suspension of about 0.5-10 wt %. Suitable supramolecular templates are characterized by constrained diffusion within the micropore channels of parent FAU zeolite, referred to as bulky surfactants or bulky supramolecular templates. Diffusion of supramolecular template molecules into micropore-channels or cavities encourages FAU zeolite dissolution. This is minimized in the top-down methods for synthesis of hierarchically ordered FAU zeolites having well-defined long-range mesoporous ordering disclosed herein, wherein effective supramolecular templates minimize diffusion or partial diffusion thereof into FAU zeolite pore-channels, cavities or window openings. Such supramolecular templates possess suitable dimensions to block such diffusion. The suitable dimensions can be a based on dimensions of a head group and/or a tail group of a supramolecular template. In certain embodiments suitable dimensions can be based on a co-template having one or more components with suitable head and/or tail groups, or being a template system arranged in such a way, so as to minimize or block diffusion in to FAU zeolite pore-channels, cavities or window openings. By minimizing diffusion of templates into the FAU zeolite pore channels, FAU zeolite dissolution into oligomers and comprehensive reorganization and assembly into the hierarchically ordered FAU zeolites having well-defined long-range mesoporous ordering disclosed herein is encouraged. In certain embodiments, a supramolecular template is one in which at least a substantial portion, a significant portion or a major portion of the surfactant does not enter into pores and/or channels of the FAU zeolite. For example, organosilanes (~0.7 nm) are relatively large compared to quaternary ammonium surfactants without such bulky groups including cetyltrimethylammonium bromide (CTAB) (~0.25 nm). In certain embodiments, a supramolecular template contains a long chain linear group (>~0.6 nm). In certain embodiments, a supramolecular template contains an aromatic or aromatic derivative group (>~0.6 nm). In certain embodiments, supramolecular templates contain one or more bulky groups having a dimension based on modeling of molecular dimensions as a cuboid having dimensions A, B and C, using Van der Waals radii for individual atoms, wherein one or more, two or more, or all three of the dimensions A, B and C are sufficiently close in dimension, or sufficiently larger in dimension, that constrains diffusion into the micropores of the selected parent FAU zeolite.

In certain embodiments an effective surfactant as a supramolecular template contains at least one moiety, as a head group or a tail group, selected from the group consisting of organosilanes, hydroxysilyls, alkoxysilyls, aromatics, branched alkyls, sulfonates, carboxylates, phosphates and combinations comprising one of the foregoing moieties. In certain embodiments an effective supramolecular template is an organosilane that contains at least one hydroxysilyl as a head group moiety. In certain embodiments an effective supramolecular template is an organosilane that contains at least one hydroxysilyl as a tail group moiety. In certain embodiments an effective supramolecular template is an organosilane that contains at least one alkoxysilyl as a head group moiety. In certain embodiments an effective supramolecular template is an organosilane that contains at least one alkoxysilyl as a tail group moiety. In certain embodiments an effective supramolecular template contains at least one aromatic as a head group moiety. In certain embodiments an effective supramolecular template contains at least one aromatic as a tail group moiety. In certain embodiments an effective supramolecular template contains at least one branched alkyl as a head group moiety. In certain embodiments an effective supramolecular template contains at least one branched alkyl as a tail group moiety. In certain embodiments an effective supramolecular template contains at least one sulfonate as a head group moiety. In certain embodiments an effective supramolecular template contains at least one sulfonate as a tail group moiety. In certain embodiments an effective supramolecular template contains at least one carboxylate as a head group moiety. In certain embodiments an effective supramolecular template contains at least one carboxylate as a tail group moiety. In certain embodiments an effective supramolecular template contains at least one phosphate as a head group moiety. In certain embodiments an effective supramolecular template contains at least one phosphate as a tail group moiety. These moieties are characterized by one or more dimensions that constrain diffusion into pores of a parent FAU zeolite. In certain embodiments, in which the FAU zeolite is characterized by pores of various dimensions, the selected moieties are characterized by one or more dimensions that constrain diffusion into the largest pores the parent FAU zeolite.

In certain embodiments an effective supramolecular template contains at least one cationic moiety. In certain embodiments an effective supramolecular template contains at least one cationic moiety selected from the group consisting of a quaternary ammonium moiety and a phosphonium moiety. In certain embodiments an effective supramolecular template contains at least one quaternary ammonium group having a terminal alkyl group with 6-24 carbon atoms. In certain embodiments an effective supramolecular template contains two quaternary ammonium groups wherein an alkyl group bridging the quaternary ammonium groups contains 1-10 carbon atoms. In certain embodiments an effective supramolecular template contains at least one quaternary ammonium group, and at least one constituent group, a head group moiety as described above. In certain embodiments an effective supramolecular template contains at least one quaternary ammonium group, and at least one constituent group, a tail group moiety as described above. In certain embodiments an effective supramolecular template contains at least one quaternary ammonium group, at least one constituent group, a head group moiety as described above, and an alkyl group that contains 1-10 carbon atoms bridging at least one of the quaternary ammonium groups and at least one of the head groups. In certain embodiments an effective supramolecular template contains at least one quaternary ammonium group, at least one constituent group, a tail group moiety as described above, and an alkyl group that contains 1-10 carbon atoms bridging at least one of the quaternary ammonium groups and at least one of the tail groups.

In certain embodiments an effective supramolecular template comprises a quaternary ammonium compound and a constituent group comprising one or more bulky organosilane or alkoxysilyl substituents. In certain embodiments an effective supramolecular template comprises a quaternary ammonium compound and a constituent group comprising one or more long-chain organosilane or alkoxysilyl substituents. In certain embodiments an effective supramolecular template cation comprises dimethyloctadecyl(3-trimethoxysilyl-propyl)-ammonium or derivatives of dimethyloctadecyl(3-trimethoxysilyl-propyl)-ammonium. In certain embodiments an effective supramolecular template cation comprises dimethylhexadecyl(3-trimethoxysilyl-propyl)-ammonium or derivatives of dimethylhexadecyl(3-trimethoxysilyl-propyl)-ammonium. In certain embodiments an effective supramolecular template cation comprises a double-acyloxy amphiphilic organosilane such as [2,3-bis(dodecanoyloxy)-propyl](3-(trimethoxysilyl)propyl)-dimethylammonium or derivatives of [2,3-bis(dodecanoyloxy)-propyl](3-(trimethoxysilyl)propyl)-dimethylammonium.

In certain embodiments an effective supramolecular template comprises a quaternary phosphonium compound and a constituent group comprising one or more bulky aromatic substituents. In certain embodiments an effective supramolecular template comprises a quaternary phosphonium compound and a constituent group comprising one or more bulky alkoxysilyl or organosilane substituents.

In certain embodiments an effective supramolecular template contains a tail group moiety selected from the group consisting of aromatic groups containing 6-50, 6-25, 10-50 or 10-25 carbon atoms, alkyl groups containing 1-50, 1-25, 5-50, 5-25, 10-50 or 10-25 carbon atoms, aryl groups containing 1-50, 1-25, 5-50, 5-25, 10-50 or 10-25 carbon atoms, or a combination of aromatic and alkyl groups having up to 50 carbon atoms. In certain embodiments an effective supramolecular template contains a head group moiety selected from the group consisting of aromatic groups containing 6-50, 6-25, 10-50 or 10-25 carbon atoms, alkyl groups containing 1-50, 1-25, 5-50, 5-25, 10-50 or 10-25 carbon atoms, aryl groups containing 1-50, 1-25, 5-50, 5-25, 10-50 or 10-25 carbon atoms, or a combination of aromatic and alkyl groups having up to 50 carbon atoms. In certain embodiments an effective supramolecular template contains co-templated agents selected from the group consisting of quaternary ammonium compounds (including for example quaternary alkyl ammonium cationic species) and quaternary phosphonium compounds.

In certain embodiments effective supramolecular templates comprise (a) at least one of: aromatic quaternary ammonium compounds, branched alkyl chain quaternary ammonium compounds, alkyl benzene sulfonates, alkyl benzene phosphonates, alkyl benzene carboxylates, or substituted phosphonium cations; and (b1) and a constituent group comprising at least one of organosilanes, hydroxysilyls, alkoxysilyls, aromatics, branched alkyls, sulfonates, carboxylates or phosphates, as a head group; or (b2) and a constituent group comprising at least one of organosilanes, hydroxysilyls, alkoxysilyls, aromatics, branched alkyls, sulfonates, carboxylates or phosphates, as a tail group. In certain embodiments effective supramolecular templates include a sulfonate group (a non-limiting example is sulfonated bis(2-hydroxy-5-dodecylphenyl)methane (SBHDM)). In certain embodiments effective supramolecular templates include a carboxylate group (a non-limiting example is sodium 4-(octyloxy)benzoate). In certain embodiments effective supramolecular templates include a phosphonate group (a non-limiting example is tetradecyl(1,4-benzene)bisphosphonate). In certain embodiments effective supramolecular templates include an aromatic group (a non-limiting example is benzylcetyldimethylammonium chloride). In certain embodiments effective supramolecular templates include an aliphatic group (a non-limiting example is tetraoctylammonium chloride).

The supramolecular template is provided as a cation/anion pair. In certain embodiments a cation of a supramolecular template is as described above is paired with an anion selected such as Cl⁻, Br⁻, OH⁻, F⁻ and I⁻. In certain embodiments a cation of a supramolecular template is as described above is paired with an anion such as Cl⁻, Br⁻ or OH⁻. In certain embodiments an effective supramolecular template comprises dimethyloctadecyl[3-(trimethoxysilyl)propyl]ammonium chloride (commonly abbreviated as “TPOAC”) or derivatives of dimethyloctadecyl[3-(trimethoxysilyl)propyl]ammonium chloride. In certain embodiments an effective supramolecular template comprises dimethylhexadecyl[3-(trimethoxysilyl)propyl]ammonium chloride or derivatives of dimethylhexadecyl[3-(trimethoxysilyl)propyl]ammonium chloride. In certain embodiments an effective supramolecular template comprises [2,3-bis(dodecanoyloxy)-propyl](3-(trimethoxysilyl)propyl)-dimethylammonium iodide or derivatives of [2,3-bis(dodecanoyloxy)-propyl](3-(trimethoxysilyl)propyl)-dimethylammonium iodide.

In certain embodiments, the system includes an effective amount of an ionic co-solute (that is, in addition to the anion paired with the supramolecular template). In certain embodiments in which an ionic co-solute is used it is provided at a concentration in the aqueous suspension of about 0.01-0.5 M. In certain embodiments in which an ionic co-solute is used it is provided at a concentration in the aqueous suspension of about 0.01-5 wt %. In certain embodiments an ionic co-solute is selected from the group consisting of CO₃²⁻, SO₄²⁻, S₂O₃²⁻, H₂PO₄⁻, F⁻, Cl⁻, Br⁻, NO₃⁻, I⁻, ClO₄⁻, SCN⁻ and C₆H₅O₈⁻³ (citrate). In certain embodiments an ionic co-solute is selected from the group consisting of SO₄²⁻, NO₃⁻, and ClO₄⁻. In certain embodiment an ionic co-solute is selected based on the Hofmeister series/Lyotropic series to control the curvature/shape of the micelles to yield the desired mesophase symmetry, for example, hexagonal or cubic. In certain embodiments a nitrate (NO₃⁻) is an ionic co-solute selected based on the Hofmeister series/Lyotropic series to control the curvature/shape of the micelles to yield hierarchically ordered FAU zeolites having well-defined long-range mesoporous ordering possess a cubic mesophase symmetry; in certain embodiments using nitrate as an ionic co-solute, a nitrate salt is used, such as ammonium nitrate or a metal nitrate, wherein the metal can be an alkali metal, an alkali earth metal, a transition metal, a noble metal or a rare earth metal. In certain embodiments a sulfate (SO₄²⁻) is an ionic co-solute selected based on the Hofmeister series/Lyotropic series to control the curvature/shape of the micelles to yield hierarchically ordered FAU zeolites having well-defined long-range mesoporous ordering possess a hexagonal mesophase symmetry; in certain embodiments using sulfate as an ionic co-solute, a sulfate salt is used, such as ammonium sulfate or a metal sulfate, wherein the metal can be an alkali metal, an alkali earth metal, a transition metal, a noble metal or a rare earth metal.

The present disclosure is applicable to various types of FAU zeolites as a parent material, including zeolite or zeolite-type materials. In certain embodiments a parent FAU zeolite exhibits both good crystallinity and Al-distribution to obtain high-quality hierarchically ordered FAU zeolites while minimizing composite phases and/or impurities.

Suitable zeolitic materials as a parent CMM include those identified by the International Zeolite Association, including those with the identifier FAU. In certain embodiments a parent zeolite can be (FAU) framework zeolite, which includes USY, for example having a micropore size related to the 12-member ring when viewed along the [111] direction of 7.4×7.4 Å.

As described above, embodiments herein include supramolecular templates that contain one or more bulky groups having a dimension based on modeling of molecular dimensions as a cuboid having dimensions A, B and C, using Van der Waals radii for individual atoms, wherein one or more, two or more, or all three of the dimensions A, B and C are sufficiently close in dimension, or sufficiently larger in dimension, that constrains diffusion into the micropores of the FAU zeolite. Also as described above with respect to the known parameters related to pore dimensions for exemplary zeolites, such parameters influence the selection of a supramolecular template. For instance, in the examples herein, FAU zeolite is used; when the supramolecular template material was CTAB (~0.25 nm), hierarchically ordered FAU zeolites were not realized; however, when the supramolecular template was an organosilane (~0.7 nm), hierarchically ordered FAU zeolites were realized, as these are closer in dimension to the pore dimensions for FAU zeolite and therefore are constrained from entering such pores. Likewise, suitable supramolecular templates are determined based on a selected parent FAU zeolite.

In certain embodiments parent FAU zeolites used in the methods are zeolites herein having a SAR suitable for the particular type of zeolite. In general, the SAR of parent zeolites can be in the range of about 5-200, 5-150, 5-100, 5-80, 10-200, 10-150, 10-100, 10-80, 50-200, 50-150 or 50-100. In certain embodiments the SAR of the parent zeolite is greater than or equal to 5 or 10 to achieve long-range ordering. In embodiments with a SAR of less than 10, uniform mesoporosity and certain degree of ordering is attainable, and amorphous framework material remains in the product.

FIGS. 1 and 2 are schematic overviews of the hierarchical ordering by post-synthetic ensembles synthesis route described herein, including the general synthesis mechanism of and how AHE influences g values to alter the micellar curvature and induce mesophase transition.

The method includes base-mediated dissolution/incision of parent FAU zeolites into oligomeric components, and reorganization into hierarchically ordered mesostructures by supramolecular templating, and in certain embodiments by the Hofmeister effect. The parent FAU zeolite 10 is provided in crystalline form. An effective amount of an alkaline reagent and an effective amount of a surfactant for supramolecular templating are added to form an aqueous suspension, and that suspension is maintained under hydrothermal conditions to form oligomeric FAU zeolite units 12 of the parent FAU zeolite (such as oligomeric zeolitic units when the parent FAU zeolite is zeolite). The supramolecular template molecules 14 form into shaped micelles 16 (not shown in FIG. 2) and oligomeric FAU zeolite units hierarchically reassemble and crystallize around the shaped micelles as an ordered mesostructure, hierarchically ordered FAU zeolite 18, having mesopores 20 of defined symmetry and mesopore walls formed of the oligomeric FAU zeolite units thereby retaining micropores 22 of the underlying FAU zeolite structure of the parent FAU zeolite. In certain embodiments, a composition of matter produced by the method herein is the hierarchically ordered FAU zeolite 18 that contains shaped micelles 16. In certain embodiments, a composition of matter produced herein is the hierarchically ordered FAU zeolite 18 having the surfactant 14 formed into shaped micelles 16 removed, for example by: chemical methods such as solvent extraction, chemical oxidation, or ionic liquid treatment; or physical methods such as calcination, supercritical CO₂, microwave-assisted treatment, ultrasonic-assisted treatment, ozone treatment, or plasma technology.

Distinctive mesophase transitions of hierarchical ensembles to yield distinct mesostructures can be attributed to the synergetic action of the anionic Hofmeister effect (ion-specific interactions) in supramolecular self-assembly. Anions of different sizes and charges possess different polarizabilities, charge densities, and hydration energies in aqueous solutions. When paired with a positive surfactant head group, these properties can affect the electrostatic repulsions among the head groups and hydration at the micellar interface, thus changing the area of the head group (a₀). Such short-range ion-specific interactions can be a significant driving force in changing the micellar curvature and inducing mesophase transition.

Referring to FIG. 2, the general synthesis mechanism is shown including a schematic representation of how AHE influences g values to alter the micellar curvature and induce mesophase transition. The surfactant (also referred to herein as the supramolecular template) to co-solute molar ratio (which may be expressed as a surfactant to salt molar ratio) is effective to produce the desired mesoporous structure. The surfactant to co-solute molar ratio is selected to result in surfactant packing parameters suitable to induce the mesophase transitions to the desired geometry inducing changes to the curvature of the micelles. For example, when a sulfate is used as an ionic co-solute, the micellar curvature is represented by a surfactant packing parameter g of about ½, or about 0.4-0.6, or 0.5, and the resulting hierarchically ordered FAU zeolite possesses long-range mesoporous ordering of hexagonal symmetry. When a nitrate is used as an ionic co-solute, the micellar curvature is represented by a surfactant packing parameter g in the range of about ½ to about ⅔, or about 0.4-0.8, 0.4-0.67, 0.5-0.8 or 0.5-0.67, and the resulting hierarchically ordered FAU zeolite possesses long-range mesoporous ordering of cubic symmetry. For example, in certain embodiments a surfactant to co-solute molar ratio for synthesis of hierarchically ordered FAU zeolite possessing long-range mesoporous ordering of hexagonal symmetry may be in the range of about 0.8-1.3, 0.9-1.3, 0.9-12 or 0.8-1.2. For example, in certain embodiments a surfactant to co-solute molar ratio for synthesis of hierarchically ordered FAU zeolite possessing long-range mesoporous ordering of cubic symmetry may be in the range of about 0.8-1.3, 0.9-1.3, 0.9-12 or 0.8-1.2. It is appreciated that wider ranges may be applicable, as recited herein, and that these ranges may vary depending on the selected surfactant and co-solutes that influence the values of V (total volume of surfactant tails), a₀ (area of the head group) and 1 (length of surfactant tail) to determine g (surfactant packing parameter). In certain embodiments, the ranges of surfactant packing parameter g and/or the ranges of surfactant to co-solute molar ratio are effective for an organosilane supramolecular template, for example, dimethyloctadecyl(3-trimethoxysilyl-propyl)-ammonium or a derivative of dimethyloctadecyl(3-trimethoxysilyl-propyl)-ammonium.

FIG. 2 also shows the influence of ion-specific interactions (The Hofmeister effect) on the micellar curvature in a self-assembly process. Anions of different sizes and charges possess different polarizabilities, charge densities and hydration energies in aqueous solutions. When paired with a positive surfactant head group, these properties can affect the electrostatic repulsions among the head groups and hydration at the micellar interface, thus changing the area of the head group (a₀). Such short-range ion-specific interactions can be a significant driving force in changing the micellar curvature and inducing mesophase transition. Based on the Hofmeister series (SO₄²⁻>HPO₄²⁻>Oac⁻>Cl⁻>Br⁻>NO₃⁻>ClO₄⁻>SCN⁻), the strongly hydrated ions (left side of series) can increase the micellar curvature, whereas weakly hydrated ions can decrease the micellar curvature. While not wishing to be bound by theory, influence of co-solutes such as salts in mesophase ordering can be attributed to their charge-balancing effect; in the surfactant self-assembly, a high density of surfactant molecules is closely packed into micelles due to the hydrophobic effect; as a result, electrostatic repulsions of the charged head group should be minimized by the counter anions to induce facile aggregation; as such auxiliary counteranions play a role in stabilizing the micelles despite the gradual changes in the concentration of polyanionic zeolite components.

An effective amount of a solvent is used in the process. In certain embodiments the solvent is water. In certain embodiments the solvent is water in the presence of co-solvents selected from the group consisting of polar solvents, non-polar solvents and pore swelling agents (such as 1,3,5-trimethylbenzene). In certain embodiments the solvent selected from the group consisting of polar solvents, non-polar solvents and pore swelling agents (such as 1,3,5-trimethylbenzene), in the absence of water. In an embodiment, mixture components are added with water to the reaction vessel prior to heating. Typically, water allows for adequate mixing to realize a more homogeneous distribution of the suspension components, which ultimately produces a more desirable product because each crystal is more closely matched in properties to the next crystal. Insufficient mixing could result in undesirable products with respect to amorphous phases or a lesser degree of long-range order.

The suspension components are combined in any suitable sequence and are sufficiently mixed to form a homogeneous distribution of the suspension components. The suspension can be maintained in an autoclave under autogenous pressure (from the components or from the components plus an addition of a gas purge into the vessel prior to heating), or in another suitable vessel, under agitation such as by stirring, tumbling and/or shaking. Mixing of the suspension components is conducted between about 20-60, 20-50 or 20-40° C.

The steps of incision and reassembly occur during hydrothermal treatment to form a solid (product, hierarchically ordered FAU zeolites having well-defined long-range mesoporous ordering) suspended in a supernatant (mother liquor). Hydrothermal treatment is conducted: for a period of about 4-168, 12-168, 24-168, 4-96, 12-96 or 24-96 hours; at a temperature of about 70-250, 70-210, 70-180, 70-160, 70-150, 90-250, 90-210, 90-180, 90-160, 90-150, 110-250, 110-210, 110-180, 110-160, or 110-150° C.; and at a pressure of about atmospheric to autogenous pressure. In certain embodiments hydrothermal treatment occurs in a vessel that is the same as that used for mixing, or the suspension is transferred to another vessel (such as another autoclave or low-pressure vessel). In certain embodiments the vessel used for hydrothermal treatment is static. In certain embodiments the vessel used for hydrothermal treatment is under agitation that is sufficient to suspend the components.

The hierarchically ordered FAU zeolites having well-defined long-range mesoporous ordering is the product recovered. The solids are recovered using known techniques such as centrifugation, decanting, gravity, vacuum filtration, filter press, or rotary drums. The recovered hierarchically ordered FAU zeolites having well-defined long-range mesoporous ordering is dried, for example at a temperature of about 50-150, 50-120, 80-150 or 80-120° C., at atmospheric pressure or under vacuum conditions, for a time of about 0.5-96, 12-96 or 24-96 hours.

In certain embodiments, the dried hierarchically ordered FAU zeolites having well-defined long-range mesoporous ordering is calcined, for example to remove supramolecular templates that remain in the mesopores and other constituents from the mesopores and/or the discrete zeolite cell micropores. The conditions for calcination in embodiments in which it is carried out can include temperatures in the range of about 350-650, 350-600, 350-550, 500-650, 500-600 or 500-550° C., atmospheric pressure or under vacuum, and a time period of about 2.5-24, 2.5-12, 5-24 or 5-12 hours. Calcining can occur with ramp rates in the range of from about 0.1-10, 0.1-5, 0.1-3, 1-10, 1-5 or 1-3° C. per minute. In certain embodiments calcination can have a first step ramping to a temperature of between about 100-150° C. with a holding time of from about 1.5-6 or 1-12 hours (at ramp rates of from about 0.1-5, 0.1-3, 1-5 or 1-3° C. per min) before increasing to a higher temperature with a final holding time in the range of about 1.5-6 or 1-12 hours.

In certain embodiments, the supernatant remaining after recovery of product from the system is recovered, and all or a portion thereof can be reused as all or a portion of the solution in a subsequent process for synthesis of hierarchically ordered FAU zeolites having well-defined long-range mesoporous ordering. In this embodiment, recovered supernatant used in subsequent process is referred to as supernatant from a prior synthesis. In certain embodiments a new synthesis can occur using supernatant from a prior synthesis together with parent FAU zeolite. In certain embodiments a new synthesis can occur using supernatant from a prior synthesis together with parent FAU zeolite and an additional quantity of make-up alkaline reagent (for example urea). In certain embodiments a new synthesis can occur using supernatant from a prior synthesis together with parent FAU zeolite and an additional quantity of make-up supramolecular template. In certain embodiments a new synthesis can occur using supernatant from a prior synthesis together with parent FAU zeolite and an additional quantity of make-up ionic co-solute. In certain embodiments a new synthesis can occur using supernatant from a prior synthesis together with parent FAU zeolite and an additional quantity of make-up alkaline reagent (for example urea) and/or make-up supramolecular template and/or optional make-up ionic co-solute.

The composition of matter recovered as described herein are hierarchically ordered FAU zeolites having well-defined long-range mesoporous ordering. These are characterized by defined mesoporous channel directions with zeolite micropore channels in the walls of the mesostructure. The hierarchically ordered FAU zeolites having well-defined long-range mesoporous ordering recovered from synthesis possesses supramolecular template as described herein in the mesopores (that is, prior to calcination or extraction of the supramolecular template). In certain embodiments the hierarchically ordered FAU zeolites having well-defined long-range mesoporous ordering recovered from synthesis possesses micelles of supramolecular template as described herein in the mesopores (that is, prior to calcination or extraction of the supramolecular template). The composition of matter recovered as described herein retains the structural integrity of the microporous zeolite structure by controlled incision of the parent zeolite followed by controlled reassembly of the zeolite oligomers under a controlled micellar curvature to yield the hierarchically ordered FAU zeolites with defined mesoporous symmetry.

This well-defined long-range mesoporosity is elusive in the field of hierarchically ordered zeolites. The long-range order is defined by secondary peaks associated with the periodic arrangement of mesopores in x-ray diffraction (XRD) patterns for the given mesophase, and/or by observations in microscopy, as demonstrated in the examples herein. These peaks associated with the mesoporous traits of the products are observed at low 2θ angles. The material also exhibits high-angle peaks associated with the zeolites and are observed at high 2-theta angles. In certain embodiments the low-angle peaks refer to those occurring at 2θ angles less than about 6°.

In certain embodiments herein, long-range mesoporous ordering of hierarchically ordered FAU zeolites produced according to the methods described herein are characterized by the mesopore periodicity repeating over a length of greater than about 50 nm.

In certain embodiments herein, hierarchically ordered FAU zeolites produced according to the methods described herein are cubic mesophase possessing Ia-3d symmetry and long-range mesoporous ordering is characterized by secondary XRD peaks associated with the periodic arrangement of mesopores are present at one or more of the (220), (321), (400), (420) and (332) reflections. In certain embodiments herein, hierarchically ordered FAU zeolites produced according to the methods described herein are hexagonal mesophase possessing p6 mm symmetry and long-range mesoporous ordering is characterized by secondary peaks in XRD that are present at (11) and/or (20) reflections.

In certain embodiments herein, hierarchically ordered FAU zeolites having well-defined long-range mesoporous ordering produced according to the methods described herein possess a surface area of about 200-1500, 200-1000, 200-900, 400-1500, 400-1000, 400-900, 500-1500, 500-1000 or 500-900 m²/g. In embodiments herein, the hierarchically ordered FAU zeolites having well-defined long-range mesoporous ordering produced according to the methods described herein possess mesoporous pore size of about 2-50, 2-20 or 2-10 nm. In embodiments herein, the hierarchically ordered FAU zeolites having well-defined long-range mesoporous ordering produced according to the methods described herein possess a silica-to-alumina ratio of about 2.5-1500, 3-1500, 4-1500, 5-1500, 6-1500, 2.5-1000, 3-1000, 4-1000, 5-1000, 6-1000, 2.5-500, 3-500, 4-500, 5-500, 6-500, 2.5-100, 3-100, 4-100, 5-100, or 6-100. In embodiments herein, the hierarchically ordered FAU zeolites having well-defined long-range mesoporous ordering produced according to the methods described herein possess a total pore volume of about 0.01-1.50, 0.01-1.0, 0.01-0.75, 0.01-0.65, 0.1-1.50, 0.1-1.0, 0.1-0.75, 0.1-0.65, 0.2-1.50, 0.2-1.0, 0.2-0.75, 0.2-0.65, 0.3-1.50, 0.3-1.0, 0.3-0.75 or 0.3-0.65 cc/g.

In embodiments herein, a product produced by the above method and demonstrated in an example herein is characterized by a mesophase having cubic symmetry. In certain embodiments the product is a 3D-cubic ordered mesoporous zeolite. hierarchically ordered FAU zeolites with the mesophase having cubic symmetry are characterized by cubic mesoporous channel directions with FAU zeolite micropore channels in the walls of the mesostructure. The cubic mesophase can possess one of Ia-3d, Fm-3m, Pm-3n, Pn-3m or Im-3m symmetry. In embodiments herein the cubic mesophase possesses Ia-3d symmetry and the secondary XRD peaks associated with the periodic arrangement of mesopores are present at one or more of the (220), (321), (400), (420) and (332) reflections. In embodiments herein the cubic mesophase possesses Ia-3d symmetry and the high-degree of long-range cubic mesophase ordering is observable by microscopy viewed by the electron beam down a suitable zone axis, for example the [311], [111] or [110] zone axes. In the example herein, nitrate salt (NO₃⁻) is used as an ionic co-solute is used to generate the mesophase having cubic symmetry. In these embodiments FAU zeolite structures are arranged in a cubic symmetry on the meso-scale, where the FAU zeolite particles (regardless of their atomic-level symmetry or structure) are arranged around micelles (on the meso-scale), and whereby the micelles are arranged exhibiting cubic symmetry. Accordingly, hierarchically ordered FAU zeolites having a cubic mesophase includes FAU zeolite characterized by atomic-level symmetry and possessing micropores that are inherent to that type of FAU zeolite, arranged in a cubic symmetry at the meso-scale level with mesopores, wherein walls of the mesopores and a mass of the mesostructure between mesopores is characterized by said FAU zeolite. This is created as described herein by forming oligomers of the underlying FAU zeolite and arranging those oligomers arranged around micelles exhibiting cubic symmetry on the meso-scale. In one embodiment a hierarchically ordered FAU zeolites is provided including FAU zeolite having atomic-level cubic symmetry arranged in a cubic symmetry meso-scale, wherein during synthesis of hierarchically ordered zeolite from parent FAU zeolite, oligomers of the parent FAU zeolite are formed and arranged around micelles exhibiting cubic symmetry on the meso-scale.

In embodiments herein, a product produced by the above method and demonstrated in an example herein is characterized by a mesophase having hexagonal symmetry. In certain embodiments the product is a 2D-hexagonally ordered mesoporous zeolite. Hierarchically ordered FAU zeolites with the mesophase having hexagonal symmetry are characterized by hexagonal mesoporous channel directions with FAU zeolite micropore channels in the walls of the mesostructure. The hexagonal mesophase can possess one of p6m, p6 mm or p6₃/mmc symmetry. In embodiments herein the hexagonal mesophase possesses p6 mm symmetry and secondary XRD peaks associated with the periodic arrangement of mesopores are present at one or more of the (11) and (20) reflections. In embodiments herein the hexagonal mesophase possesses p6 mm symmetry and secondary XRD peaks are present at both the (11) and (20) reflections. In embodiments herein the hexagonal mesophase possesses p6 mm symmetry and the high-degree of long-range hexagonal p6 mm mesophase ordering is observable by microscopy viewed by the electron beam perpendicular to the pores down the [110] zone axis and/or parallel to the pores down the [001] zone axis. In these embodiments FAU zeolite structures are arranged in a hexagonal p6 mm symmetry on the meso-scale, where the FAU zeolite particles (regardless of their atomic-level symmetry or structure) are arranged around micelles (on the meso-scale), and whereby the micelles are arranged exhibiting hexagonal symmetry. Accordingly, hierarchically ordered FAU zeolites having a hexagonal p6 mm mesophase includes FAU zeolite characterized by atomic-level symmetry and possessing micropores that are inherent to that type of FAU zeolite, arranged in a hexagonal p6 mm symmetry at the meso-scale level with mesopores, wherein walls of the mesopores and a mass of the mesostructure between mesopores is characterized by said FAU zeolite. This is created as described herein by forming oligomers of the underlying FAU zeolite and arranging those oligomers arranged around micelles exhibiting hexagonal symmetry on the meso-scale. In one embodiment a hierarchically ordered FAU zeolite is provided including FAU zeolite having atomic-level cubic symmetry arranged in a hexagonal p6 mm symmetry meso-scale, wherein during synthesis of hierarchically ordered zeolite from parent FAU zeolite, oligomers of the parent FAU zeolite are formed and arranged around micelles exhibiting hexagonal symmetry on the meso-scale.

In some embodiments, the feed that can be hydrocracked with the disclosed hierarchically ordered FAU zeolite catalyst formulation is a first stage hydrocracking unit feed. In some embodiments, the feed has less than 50 ppm nitrogen. In some embodiments, the feed that can be hydrocracked with the disclosed hierarchically ordered FAU zeolite catalyst formulation is a stream that is directly after any pre-treatment of a fresh, straight-run, feed. In some embodiments, the feed has a boiling point up to 833° C.

In some embodiments, the feed that can be hydrocracked with the disclosed hierarchically ordered FAU zeolite catalyst formulation is one or more of refined oil obtained from crude oil, synthetic crude oil, bitumen, oil sand, shale oil, or coal oil. In some embodiments, the refined oil includes, but is not limited to, vacuum gas oil (VGO), deasphalted oil (DAO) obtained from a solvent deasphalting process, demetallized oil (DMO), light and/or heavy coker gas oil obtained from a coker process, cycle oil obtained from a fluid catalytic cracking (FCC) process, and gas oil obtained from a visbreaking process.

In some embodiments, the hierarchically ordered FAU zeolites-containing catalyst can be used in a hydrocracker that operates at a temperature (° C.) in the range of from 300-500, 300-450, 300-400, 300-350, 350-500, 350-450, 350-400, 400-500, 400-450, or 450-500; at a hydrogen partial pressure (MPa) in the range of from 3.5-35, 3.5-30, 3.5-20, 3.5-15, 3.5-10, 3.5-5, 5-35, 5-30, 5-20, 5-15, 5-10, 10-35, 10-30, 10-20, 10-15, 15-35, 15-30, 15-20, 20-35, 20-30, or 30-35; at a hydrogen-to-oil ratio (N·m/m³) in the range of from 500-2500, 500-2000, 500-1500, 500-1000, 1000-2500, 1000-2000, 1000-1500, 1500-2500, 1500-2000, or 2000-2500; and a liquid hourly space velocity (LHSV) (hr⁻¹) in the range of from 0.1-10, 0.1-5, 0.1-2.5, 0.1-1, 1-10, 1-5, 1-2.5, 2.5-10, 2.5-5, or 5-10.

In some embodiments, the hydrocracker comprises a flow reactor selected from the group consisting of a stirred tank reactor, an ebullient bed reactor, a baffled slurry tank, a fixed bed reactor, a rotating tubular reactor, a slurry-bed reactor, and a combination of two or more of these.

At the same conversion, the hierarchically ordered FAU zeolite formulations comprising hierarchical FAU zeolites with long range mesoporous ordering (cubic or hexagonal) show remarkable improvement in middle distillate yields when compared with an equivalent catalyst formulation (at the same normalized acidity) comprising a commercial mesoporous FAU zeolite not possessing long range mesoporous ordering. Without wishing to be bound by theory, it is believed that improved mass transfer derived from the long range mesoporous ordering in the zeolites leads to suppression of secondary cracking resulting in higher middle distillate yields.

For example, in some embodiments, middle distillate yields are increased for a hydrocracking catalyst comprising a FAU zeolite having long range mesoporous ordering of 3D cubic symmetry; while not wishing to be bound by theory, it is understood that the 3D cubic symmetry provides improved mass transfer properties, as the pores are three-dimensionally connected

In some embodiments, when an equivalent FAU zeolite has 2D hexagonal symmetry, the middle distillate yields are less than that of the equivalent catalyst comprising the FAU zeolite having long range order with 3D cubic symmetry. It is noted that the “2D” in the hexagonal system relates to the arrangement of pores (e.g. like a honeycomb arrangement), however, each pore is only 1D (like a straight pipe), and therefore, the mass transfer is not as prominent as in the 3D cubic hierarchically ordered FAU zeolites. However, in both the FAU zeolites, that is, those having 3D cubic or 2D hexagonal long range ordering, the middle distillate yields are enhanced and increased to middle distillate yields produced with commercial FAU zeolites having mesoporosity without any long range ordering.

The FAU zeolites possessing long range mesoporous ordering are expected to enhance the diffusion of reactant species to the active sites of the zeolite resulting in improved conversion and middle distillate selectivity compared to commercial FAU zeolites.

In some embodiments, the middle distillate yield is increased by up to 5% on an absolute basis when using the FAU zeolites having mesoporosity with long range ordering vs. when using a comparable commercial FAU zeolite, at an equivalent conversion and with an equivalent total acidity. In some embodiments, the middle distillate yield is increased by 1-5, 1-4, 1-3, 1-2, 2-5, 2-4, 2-5, 3-4, 3-5, or 4-5 on an absolute basis when using the FAU zeolites having mesoporosity with long range ordering vs. when using a comparable commercial FAU zeolite, at an equivalent conversion and with an equivalent total acidity.

In some embodiments, the middle distillate yield is increased by up to 15% on a delta basis when using the FAU zeolites having mesoporosity with long range ordering vs. when using a comparable commercial FAU zeolite, at an equivalent conversion and with an equivalent total acidity. In some embodiments, the middle distillate yield is increased by 1-15, 5-15, 10-15, 1-10, or 5-10% on a delta basis when using the FAU zeolites having mesoporosity with long range ordering vs. when using a comparable commercial FAU zeolite, at an equivalent conversion and with an equivalent total acidity.

### Examples

The hierarchically ordered FAU zeolites produced and used in the examples herein exhibit a remarkable degree of well-defined long-range mesoporous ordering, as given by the low-angle XRD patterns. Structural and textural properties of certain samples are provided in Table 3. The parent zeolite used in the examples and comparative examples possesses the FAU framework, zeolite Y (obtained from Zeolyst International, product name CBV 720) and is referred to herein as zeolite HY-15, having a SAR of about 30 (Si/Al atomic ratio of 15). While the examples are shown with respect to this particular zeolite, the methods herein can be applied to a parent FAU zeolite from another source and of another type as described herein, whether obtained from a commercial manufacturer obtained from a separate synthesis process. Accordingly, the resulting compositions of matter have the mesoporous structure with microporosity and FAU zeolite structure corresponding to the parent FAU zeolite. The solutions were prepared at room temperature (RT) and under stirring at 500 RPM.

Characterizations herein were carried out as follows. Powder x-ray diffraction patterns were obtained using a Bruker D8 twin diffractometer, operating at 40 kV and 40 mA having Cu Kα radiation (λ=0.154 nm) and a step-size of 0.02. N₂ physisorption measurements were conducted at 77 K using a Micromeritics ASAP 2420 instrument. All samples were degassed at 350° C. for 12 h before the analysis. The specific surface areas and pore size distributions were calculated using the Brunauer-Emmett-Teller (BET) and non-local density functional theory (NLDFT) models. Total pore volume calculated from a single point at a relative pressure (P/P₀)=0.95. The t-plot method was used to calculate the micropore volume. High-resolution transmission electron microscopy (TEM) studies were undertaken using a FEI-Titan ST electron microscope operated at 300 kV. Scanning electron microscopy (SEM) images were obtained with Nova Nano HR-SEM 240 microscope operated at 4 kV. The samples were sputter-coated with Platinum (Pt) prior to the analysis to eliminate the charge effect. The Si/Al ratios were calculated by solid-state magic-angle spinning nuclear magnetic resonance (MAS-NMR) experiments using a Bruker Advance 400 MHz instrument, applying 4 μs radio frequency pulses and a recycle delay of 60 s. Conversely, the bulk Si/Al ratios of the zeolites were calculated from the inductively coupled plasma-optical emission spectroscopy (ICP-OES) analysis performed using 5100 ICP-OES Agilent instruments. Prior to the analysis, the samples were mixed with hydrofluoric acid (HF) and nitric acid (HNO₃) and digested at 260° C. and 160 bar using an UltraWAVE microwave digestion system (Milestone).

For the acquisition of the electron micrographs for tomography reconstruction, the zeolite powder was deposited on a Quantifoil 300 mesh TEM grid supporting a 2 nm thick continuous carbon film over a holey carbon membrane. Prior to the zeolite deposition, a diluted solution of gold nanoparticles (AuNPs) around 5 nm in diameter was dispersed on the TEM grid. The AuNPs will be used in the alignment of the tomographic tilt series. To protect the specimen from beam-induced damage during the long exposure time needed for tomography data acquisition, the acquisition of the tomographic tilt series was performed at liquid nitrogen temperature on a Krios G4 (ThemoFisher™) electron microscope. The real temperature at the stage level was around −183° C. The tilt series was acquired in energy-filtered (EF) mode using a 30 eV slit for increasing the contrast of bright field TEM images. The detection was done on the Falcon i electron direct detector camera run in electron counting mode with 4096-pixel frame size. To keep the total exposure dose low, only the sample tracking was performed after each tilt series during data acquisition. The re-focusing was performed manually around every 10 images. The angular range was ±640 with a tilt step of 1°. The tilt series were aligned in the IMOD software using 13 AuNPs as fiducial markers that were clearly visible at each tilting angle. Prior to the reconstruction an image binning of 2 was performed to increase the SNR and reduce the computation time. To enhance the visibility of the pores in the 3D tomograph the images were filtered using an average background subtraction filter (ABSF) implemented as a script in Digital Micrograph. The SIRT reconstruction algorithm run with 100 iterations and a relaxation coefficient of 1 was employed.

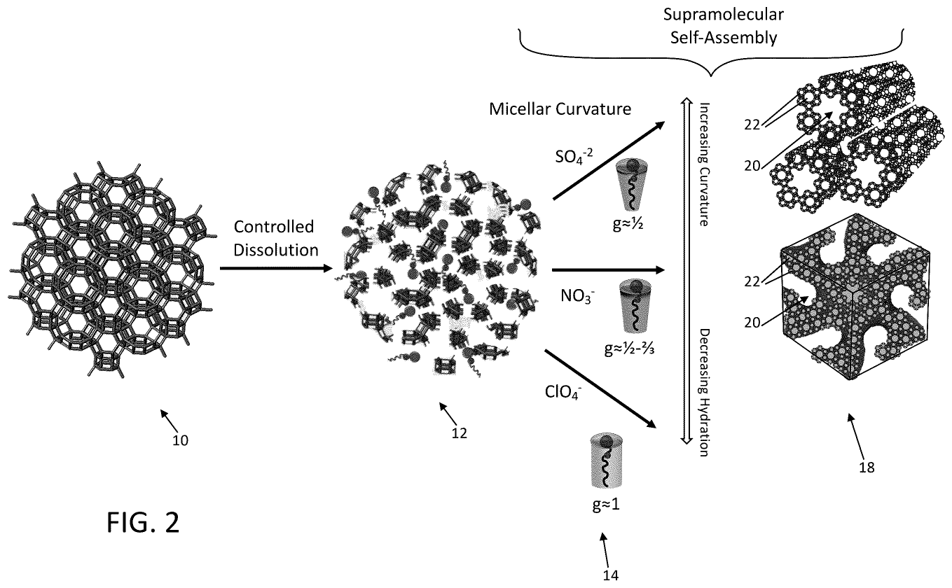

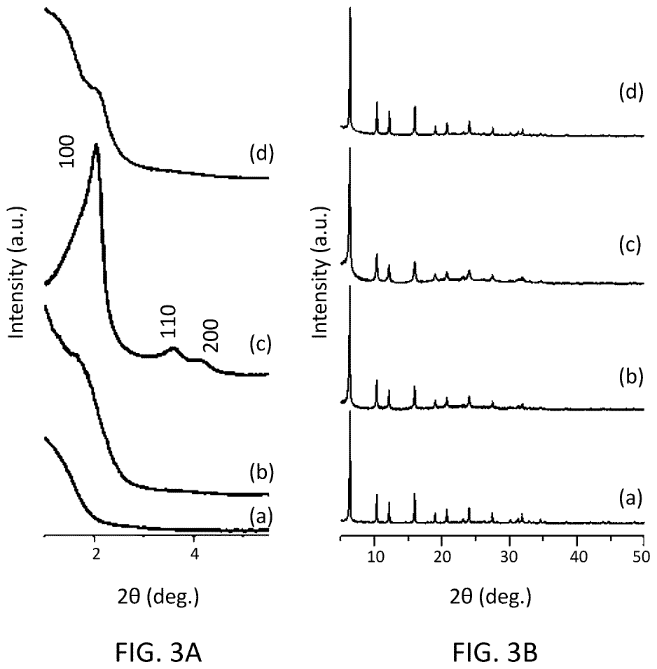

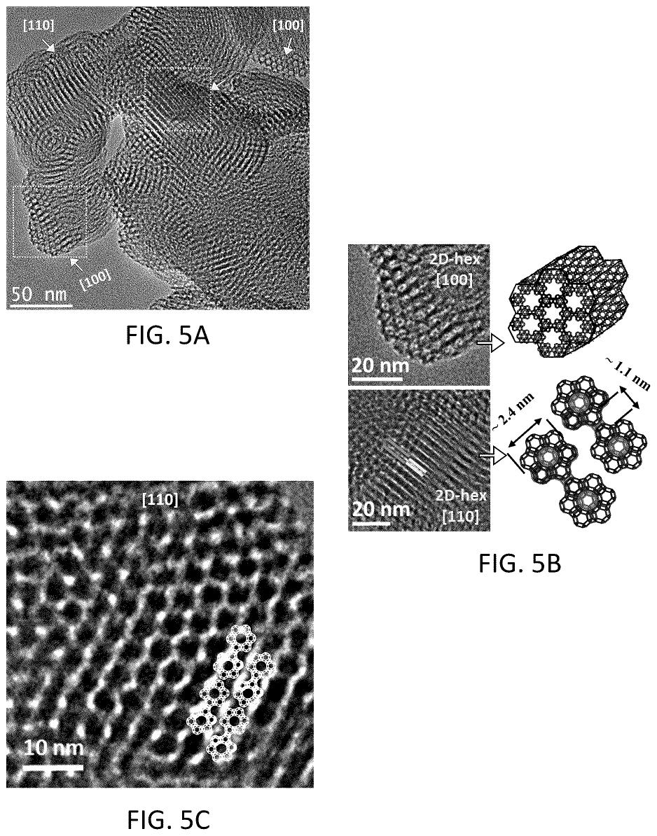

Example 1A: A quantity of 2.4 grams of NH₄OH was added to 28.3 grams of water while stirring. To this solution, a quantity of 1.0 grams of dried zeolite HY-15 was dispersed and further stirred for 0.25 hours. Then, a quantity of 0.4 grams of CTAB was added and further stirred for 0.5 hours. The resultant solution was further stirred for 1 hour, followed by hydrothermal treatment at 130° C. for 24 hours. The resulting solids were filtered, washed with water, and dried at 120° C. for 24 hours. The synthesized products were calcined in air at 550° C. for 6.0 hours at a ramp rate of 60° C./hour to yield AH-CT (where AH refers to ammonium hydroxide and CT refers to CTAB). The AH-CT synthesized in accordance this procedure exhibits disordered mesoporosity, and is characterized in FIGS. 3A-4B, with an SEM image presented in FIG. 6 and structural and textural properties provided in Table 3.

In an alternative procedure, a quantity of 2.0 grams of dried zeolite HY-15 was dispersed in 56.6 grams of water while stirring. To this solution, 0.77 grams of cetyltrimethylammonium bromide (CTAB) was added and further stirred for 0.5 hours. Subsequently, 4.75 grams of aqueous ammonium hydroxide (30 wt %) was added dropwise to the mixture under stirring. The resultant solution was further stirred for 0.5 hours, followed by hydrothermal treatment at 130° C. for 24 hours. The resulting solids were filtered, washed with water and dried at 120° C. for 24 hours. The synthesized products were calcined in air at 550° C. for 6.0 hours at a ramp rate of 60° C./hour to yield AH-CT, which exhibits disordered mesoporosity.

Example 1B: A procedure for synthesis of 2D-hexagonally ordered mesoporous FAU-type zeolites is provided.

A quantity of 2.4 grams of NH₄OH was added to 28.3 grams of water while stirring. A quantity of 1.0 grams of dried zeolite HY-15 was dispersed in the base solution and further stirred for 0.25 hours. Then, a quantity of 1.5 milliliters of dimethyloctadecyl(3-trimethoxysilyl-propyl)-ammonium chloride (DOAC) (42.0 wt % in methanol) was added and further stirred for 0.5 hours. The resultant solution was further stirred for 1 hour, followed by hydrothermal treatment at 130° C. for 24 hours. The resulting solids were filtered, washed with water, and dried at 120° C. for 24 hours. The synthesized products were calcined in air at 550° C. for 6.0 hours at a ramp rate of 60° C./hour to yield AH-TMS (where TMS refers to DOAC, dimethyloctadecyl(3-trimethoxysilyl-propyl)-ammonium chloride). The AH-TMS formed in accordance this procedure exhibits 2D-hexagonally ordered mesoporous symmetry, and is characterized in FIGS. 3A-4B, with an SEM image presented in FIG. 6 and structural and textural properties provided in Table 3.

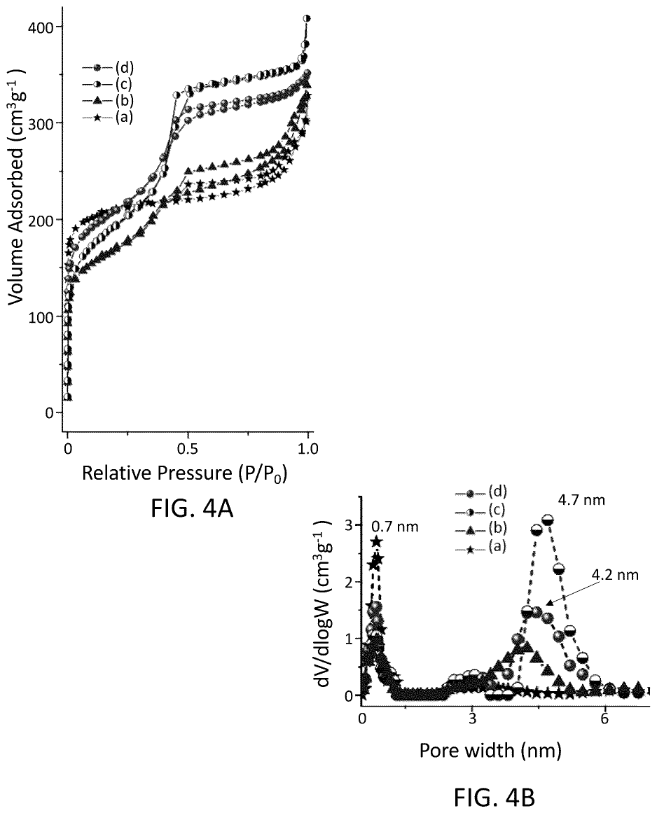

In an alternative procedure, a quantity of 2.0 grams of dried zeolite HY-15 was dispersed in 56.6 grams of water while stirring. To this dispersion, a quantity of 3.0 milliliters of organosilane, DOAC (42.0 wt % in methanol), was added and further stirred for 0.5 hours. Subsequently, 4.75 grams of aqueous ammonium hydroxide solution (30 wt %) was added dropwise to the mixture under stirring. The resultant solution was further stirred for 0.5 hours, followed by hydrothermal treatment at 130° C. for 24 hours. The resulting solids were filtered, washed with water and dried at 120° C. for 24 hours. The synthesized product was calcined in air at 550° C. for 6 hours with a ramp rate of 60° C./hour to yield AH-TMS. The AH-TMS formed in accordance with this procedure possesses 2D-hexagonally ordered mesoporous symmetry (as is apparent in the TEM images of this AH-TMS presented in FIGS. 5A-5C).

Example 1C: A quantity of 0.6 grams of urea was added to 28.3 grams of water to form a homogeneous solution. To this solution, a quantity of 1.0 grams of dried zeolite HY-15 was dispersed and further stirred for 0.5 hours. Subsequently, 20 milliliters of water and 1.5 milliliters of DOAC (42.0 wt % in methanol) were added and further stirred for 2 hours. The resultant solution was subjected to hydrothermal treatment at 130° C. for 5 days. The resulting solids were filtered, washed with water, and dried at 120° C. for 24 hours. The synthesized products were calcined in air at 550° C. for 6.0 hours at a ramp rate of 60° C./hour to yield U-TMS (where U refers to urea). The U-TMS formed in accordance this procedure exhibits poorly defined mesoporosity, and is characterized in FIGS. 3A-4B, with an SEM image presented in FIG. 6 and structural and textural properties provided in Table 3.

In an alternative procedure, a quantity of 1.2 grams of urea was dissolved in 60.0 grams of water to form a homogeneous solution. To this mixture, 2.0 grams of dried zeolite HY-15 was added and stirred for 10 minutes. Subsequently, 3.0 milliliters of DOAC (42.0 wt % in methanol) was added. The resulting solution was stirred for 0.5 hours, followed by hydrothermal treatment at 130° C. for 72 hours. The resulting mixture was filtered, washed with water and dried at 120° C. for 24 hours. The synthesized products were calcined in air at 550° C. for 6 hours with a ramp rate of 60° C./hour to yield U-TMS, which did not possess defined mesoporosity.

The calcined products from Examples 1A-1C and the reference HY-15 zeolite are characterized in FIGS. 3A-4B, in which: FIG. 3A depicts low-angle XRD patterns and FIG. 3B depicts high-angle XRD patterns with intensity expressed in arbitrary units (a.u.) plotted against frequency 2θ(°); FIG. 4A depicts N₂ physisorption isotherms plotting N₂ adsorbed (cm³·g⁻¹) against relative pressure (P/P₀); and FIG. 4B depicts non-local density functional theory (NLDFT) pore-size distributions plotting dV/d log W (cm³·g⁻¹) (wherein “a” corresponds to commercial-USY (Zeolite HY-15), “b” corresponds to AH-CT, “c” corresponds to AH-TMS and “d” corresponds to U-TMS). In the Example 1B, the product hierarchically ordered zeolites are 2D-hexagonally ordered mesoporous FAU-type zeolites, having mesoporous channels, arranged in a hexagonal manner, as observed in the [100] and [110] directions with FAU micropore channels in the walls and mass of the mesostructure between mesopores.

FIGS. 5A-C are TEM micrographs of calcined AH-TMS (formed according to the alternative procedure in Example 1B) showing hexagonal mesoporous channels in the [100] and [110] directions, wherein: FIG. 5A shows the TEM micrograph at a scale of 50 nanometers; FIG. 5B shows the TEM micrographs in the [100] direction and in the [110] direction at a scale of 20 nanometers, and also depicts corresponding schematic diagrams and unit cell dimensions; and FIG. 5C shows the TEM micrograph in the [100] direction at a scale of 10 nanometers (with an overlaying schematic diagram of the underlying zeolite structure).

FIG. 6 shows SEM images of (A) parent zeolite, HY-15; and the calcined products herein, (B) AH-CT, (C) AH-TMS and (D) U-TMS. The image (B) for AH-CT does not indicate notable changes in the morphology even at the crystal edges, whereas the image for AH-TMS does indicate changes in the morphology indicative of functionality of the organosilanes, possessing a bulkier head and silanol groups than CTAB, resulting in improved dissolution and reassembly. Regarding the U-TMS, the urea-mediated synthesis improved the crystallinity considerably (image (D) in FIG. 6) but the mesoporous structure was poorly defined as is apparent in pattern (d) of FIG. 3A. While not wishing to be bound by theory it, these contrasting results suggest that the rate of dissolution influences not only recrystallization but also supramolecular self-assembly. Mesophase organization can be influenced by numerous physicochemical phenomena, including Coulombic interactions between organic and inorganic species, hydration energy, and hydrophobic effect. In the absence of strong alkali cations, surfactant-zeolite interactions play a key role in promoting cooperative self-assembly to induce the mesophase. In the case of AH-TMS, the zeolite dissolution was instantaneous, and importantly, the —Si(OCH₃)₃ groups on the organosilane head group can readily hydrolyze to interact with anionic zeolitic components to promote mesophase. Conversely, in the case of U-TMS, the concentration of anionic inorganic components changes gradually over time, thus progressively varying the charge balance at the micellar interface, disrupting the mesophase formation.

The high-degree of long-range ordering is apparent from the low-angle XRD pattern “c” of FIG. 3A exhibiting Bragg's reflections at angles corresponding to 100, 110 and 200 planes, indicative of hexagonal mesopore symmetry in the AH-TMS. Conversely, in Example 1A, the use of relatively smaller templates or surfactant molecules (CTAB) causes diffusion inside the zeolitic pores causing inhomogeneous dissolution and preventing comprehensive reorganization. This is apparent from the low-angle XRD patterns “b” and “d” which did not exhibit a high-degree of long-range ordering despite having a uniform pore size distribution (PSD) from the corresponding N₂ physisorption isotherm (FIG. 4A), attributed to non-homogeneous zeolite dissolution and restricted supramolecular self-assembly. The retention of the underlying zeolite structure is apparent from the high-angle XRD patterns of FIG. 3B which are consistent with those for the parent zeolite, FAU zeolite, for all samples. In addition, AH-TMS demonstrates excellent hierarchically ordered mesoporosity as indicated by characteristic type-IV isotherm with H1 hysteresis (FIG. 4A). Further, a high mesopore volume and narrow pore-size distribution further supports the presence of long-range ordered mesoporosity (FIG. 4B).

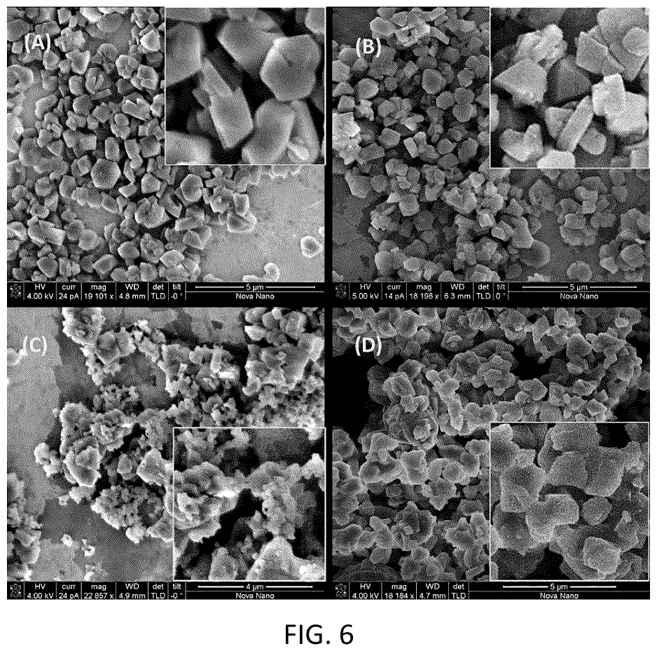

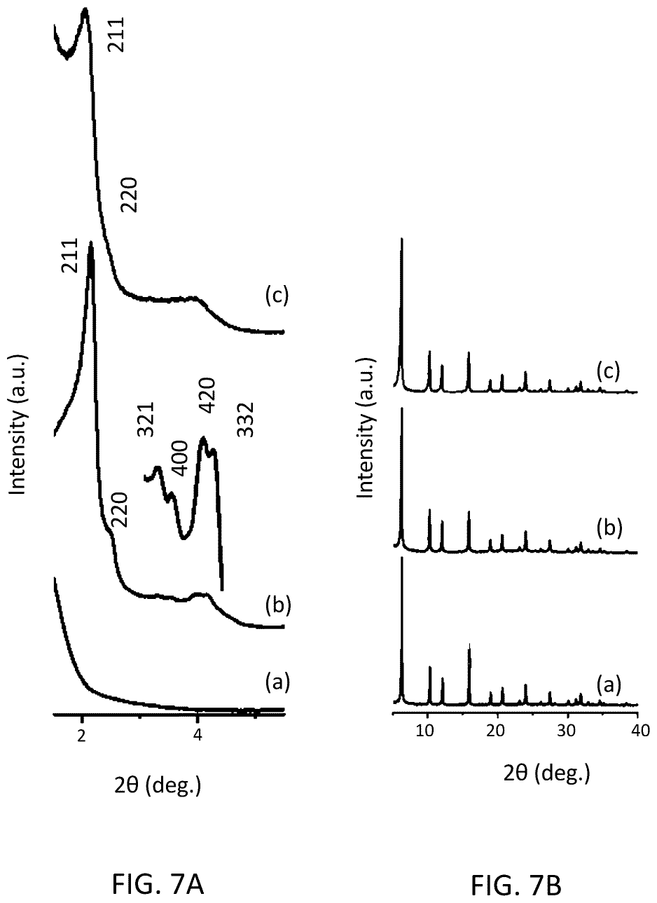

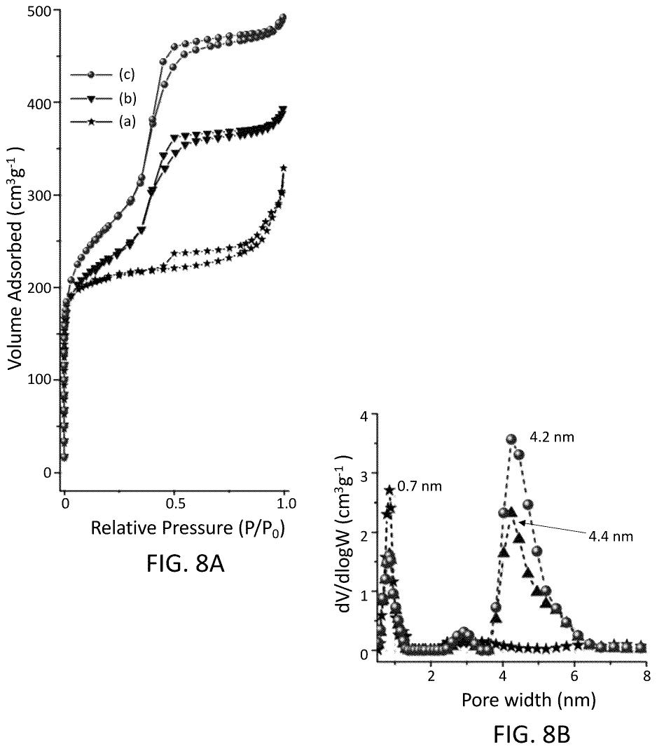

Example 2A: A procedure for synthesis of 3D-cubic ordered mesoporous FAU-type zeolites is provided. A quantity of 0.6 grams of urea was added to 10.0 grams of water to form a homogeneous solution. To this solution, a quantity of 1.0 grams of dried zeolite HY-15 was added and stirred for 0.5 hours. Subsequently, 20 milliliters of water, 0.1 grams of ammonium nitrate (NH₄NO₃) as a source of ionic co-solute and 1.5 milliliters of DOAC (42.0 wt % in methanol) were added stepwise and the mixture further stirred for 2 hours. The resultant solution was subjected to hydrothermal treatment at 130° C. for 5 days. The resulting solids were filtered, washed with water, and dried at 120° C. for 24 hours. The synthesized products were calcined in air at 550° C. for 6.0 hours at a ramp rate of 60° C./hour to yield U-N-TMS-130-a (where N refers to nitrate and “130” refers to the hydrothermal treatment temperature). The U-N-TMS-130-a formed in accordance with this procedure exhibits 3D-cubic ordered mesoporous symmetry, and is characterized in FIGS. 7A-8B, with TEM images presented in FIGS. 9A-C and structural and textural properties provided in Table 3.

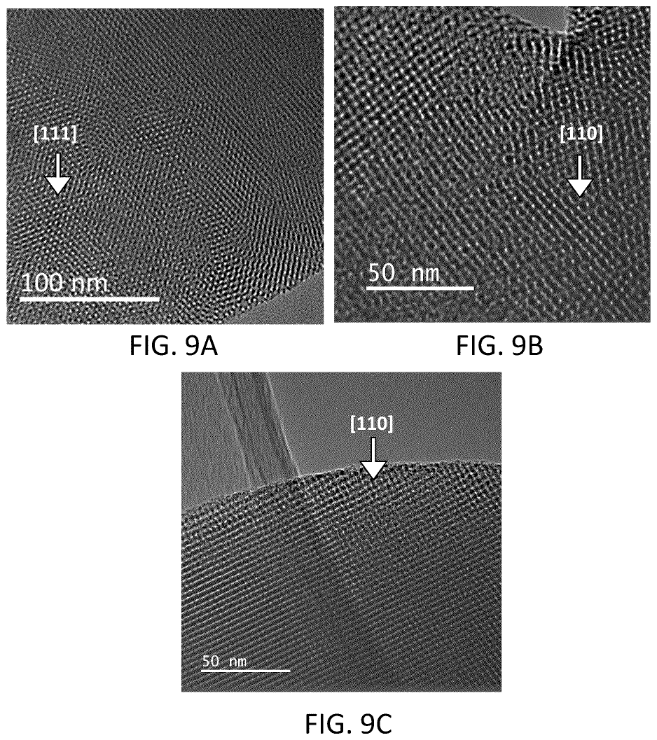

In an alternative procedure, a quantity of 1.2 grams of urea was dissolved in 60.0 grams of water to form a homogeneous solution. To this mixture, 0.2 grams of ammonium nitrate (NH₄NO₃) was added as a source of ionic co-solute, and stirred to form a homogeneous solution. 2.0 grams of zeolite HY-15 was added and stirred for 10 minutes. Subsequently, 3.0 milliliters of DOAC (42.0 wt % in methanol) was added. The resulting solution was stirred for 0.5 hours, followed by hydrothermal treatment at 130° C. for 72 hours. The resulting solids were filtered, washed with water and dried at 120° C. for 24 hours. The synthesized product was calcined in air at 550° C. for 6 hours with a ramp rate of 60° C./hour to yield U-N-TMS-130-b. The calcined U-N-TMS-130-b formed in accordance with this procedure exhibits 3D-cubic ordered mesoporous symmetry, as is apparent in the TEM images presented in FIGS. 10A-10B.

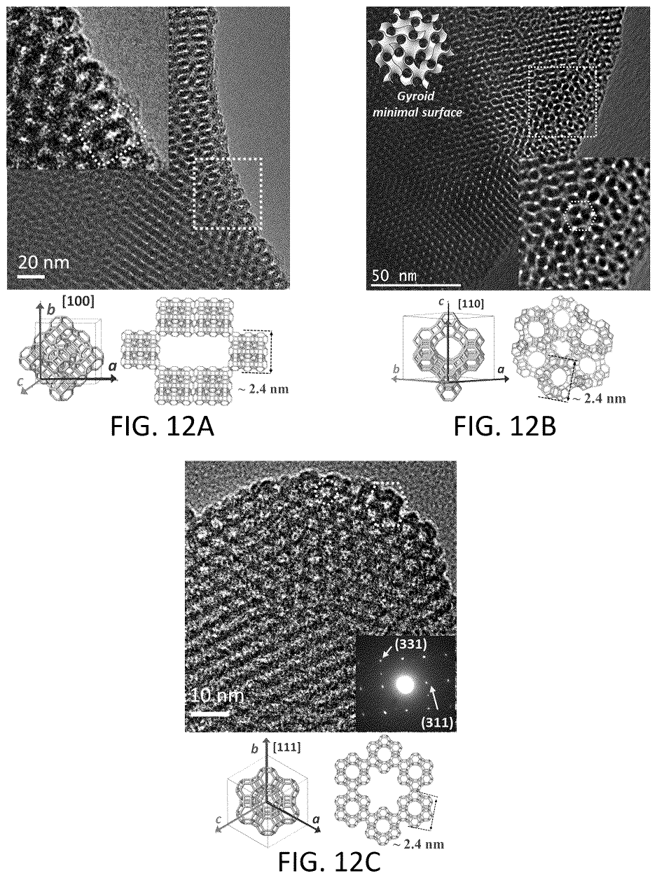

Example 2B: A procedure similar to that identified herein in the first procedure of Example 2A was followed, except that 1.0 grams of urea and 2.0 milliliters of DOAC (42.0 wt % in methanol) were used, and hydrothermal treatment was carried out at 150° C. for 72 hours. The calcined product is U-N-TMS-150-a that possessed 3D-cubic ordered mesoporous symmetry. The U-N-TMS-150-a from this procedure is characterized in FIGS. 7A-8B, and its TEM images are presented in FIGS. 12A-C and structural and textural properties provided in Table 3.

The calcined mesoporous zeolite products from Examples 2A and 2B, and the reference HY-15 zeolite, are characterized in FIGS. 7A-8B, in which: FIG. 7A depicts low-angle XRD patterns and FIG. 7B depicts high-angle XRD patterns with intensity expressed in arbitrary units (a.u.) plotted against frequency 2θ(°); FIG. 8A depicts N₂ physisorption isotherms plotting N₂ adsorbed (cm³·g⁻¹) against relative pressure (P/P₀); and FIG. 8B depicts non-local density functional theory (NLDFT) pore-size distributions plotting dV/d log W (cm³·g⁻¹) (wherein “a” corresponds to commercial-USY (Zeolite HY-15), “b” corresponds to U-N-TMS-130-a and “c” corresponds to U-N-TMS-150-a). In the Examples 2A and 2B, the product hierarchically ordered zeolites are 3D-cubic ordered mesoporous FAU-type zeolites, having cubic mesoporous channels present in the [100] and [110] directions with FAU micropore channels in the walls and mass of the mesostructure between mesopores.

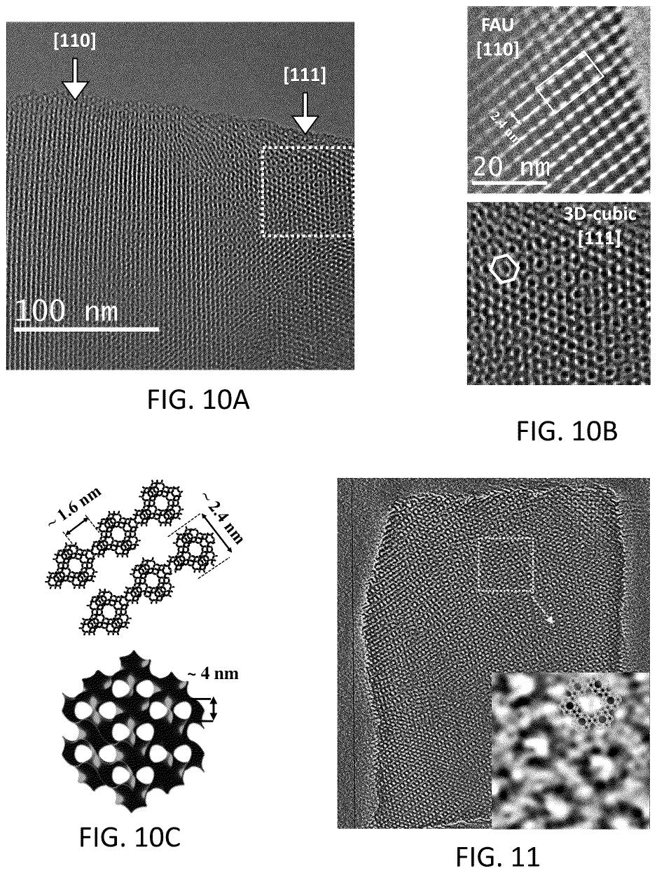

FIGS. 9A-C presents TEM micrographs of calcined U-N-TMS-130-a formed according to the first procedure of Example 2A, showing cubic mesoporous channels in the [111] and [110] directions, wherein FIG. 9A is an image in the [111] direction at a scale of 100 nanometers, and FIGS. 9B and 9C are images in the [112] direction at a scale of 50 nanometers (with the image of FIG. 9B enlarged relative to the image of FIG. 9C). FIGS. 10A-B are TEM micrographs of calcined U-N-TMS-130-b formed according to the second procedure of Example 2A showing cubic mesoporous channels in the [111] and [110] directions, wherein: FIG. 10A shows the TEM micrograph at a scale of 100 nanometers; FIG. 10B shows the TEM micrograph in the [110] direction and in the [111] direction at a scale of 20 nanometers; and FIG. 10C depicts a FAU unit cell schematic and dimensions and their arrangement to provide long-range mesoporous ordering. The high-degree of long-range ordering is apparent from the low-angle XRD patterns of FIG. 7A, exhibiting Bragg's reflections 211, 220, 321, 400, 420 and 332, which are characteristic of bicontinuous gyroid (cubic) (Ia-3d) mesopore symmetry (where the reflections at 321, 400, 420 and 332 are magnified). The retention of the underlying zeolite structure is apparent from the high-angle XRD patterns of FIG. 7B, which are consistent with those for the parent zeolite, FAU zeolite. In addition, the U-N-TMS-130-a and U-N-TMS-150-a demonstrate excellent hierarchically ordered mesoporosity as indicated by characteristic type-IV isotherm with H1 hysteresis depicted in the N₂ physisorption isotherms of FIG. 8A. Further, a high mesopore volume and narrow pore-size distribution demonstrated in FIG. 8B further supports the presence of long-range ordered mesoporosity. FIG. 11 presents an electron tomography reconstruction of U-N-TMS-150-a with an inset to magnify the pore architecture and show an overlay diagram of the structure. FIGS. 12A-C presents TEM micrographs of U-N-TMS-150-a with corresponding structural diagrams, wherein FIG. 12A is an image showing TEM micrograph at a scale of 20 nanometers in the [100] orientation, FIG. 12B is an image at a scale of 50 nanometers in the [110] orientation and FIG. 12C is an image at a scale of 10 nanometers in the [111] orientation, with insets in FIGS. 12A and 12B showing magnified images and the inset in FIG. 12C showing selected area electron diffraction (SAED). The U-N-TMS-150-a synthesized at a higher temperature demonstrated improved textural properties as a result of the thorough removal of non-framework aluminum. The 3D mesostructure by electron tomography (ET) revealed a homogenous distribution of mesoporous channels inside the zeolite volume. A longitudinal slice cut through the middle of the zeolite grain shows a continuous network of mesopores developed along a single crystallographic direction. The inset in FIG. 11 highlights the 3D spatial homogeneity of the hierarchical pore architecture. The interconnected mesopore network formed by the zeolite framework extends from the zeolite grain external facets to its core.

In addition, when comparing the products of Example 1C (U-TMS) with that of Examples 2A and 2B (U-N-TMS), the benefit of the ionic co-solute contribution of the nitrate is apparent. The ionic co-solute serves to influence the cubic micelle shape by the Hofmeister effect, around with the FAU-type zeolite oligomers are arranged. In the Example 1C there is a degree of periodicity of mesopore arrangement possibly from either a bimodal system or a structure collapse, however, there is a significant lack of any long-range ordering as compared with the products of Examples 2A and 2B having the nitrate anion where it is observed by low angle XRD showing reflections characteristic of gyrodial bicontinuous (cubic) mesopore structure (Ia-3d).

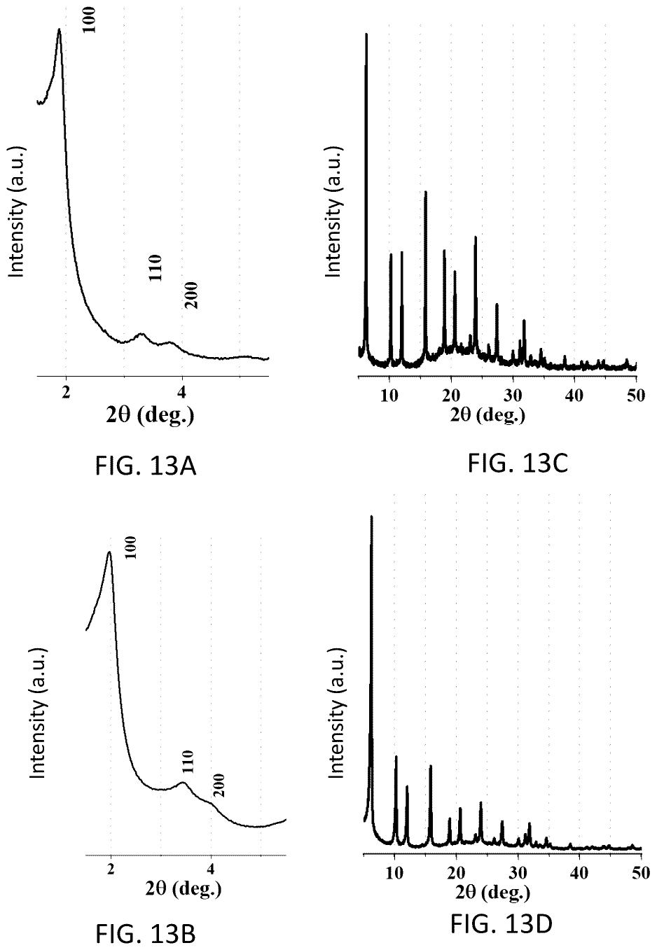

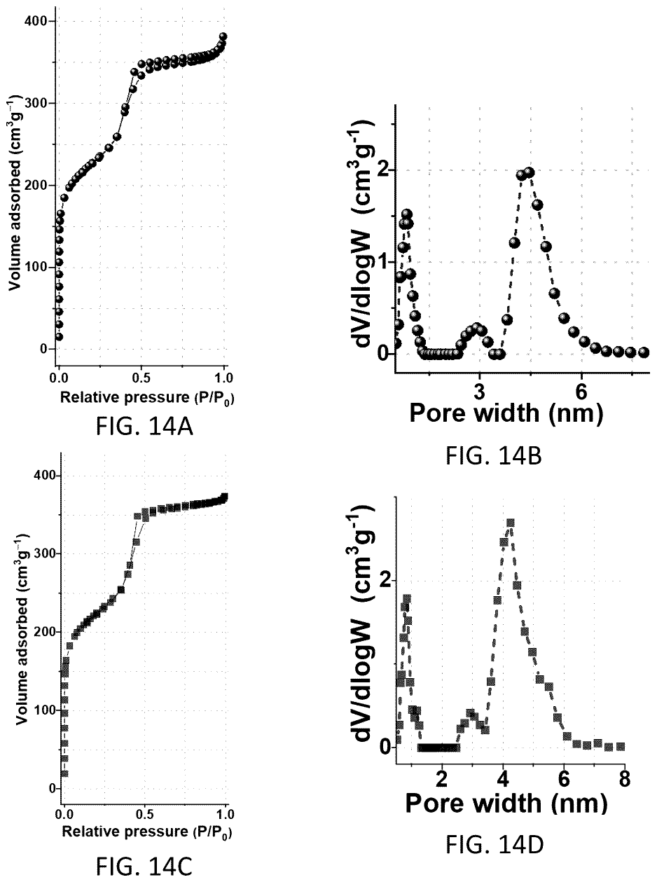

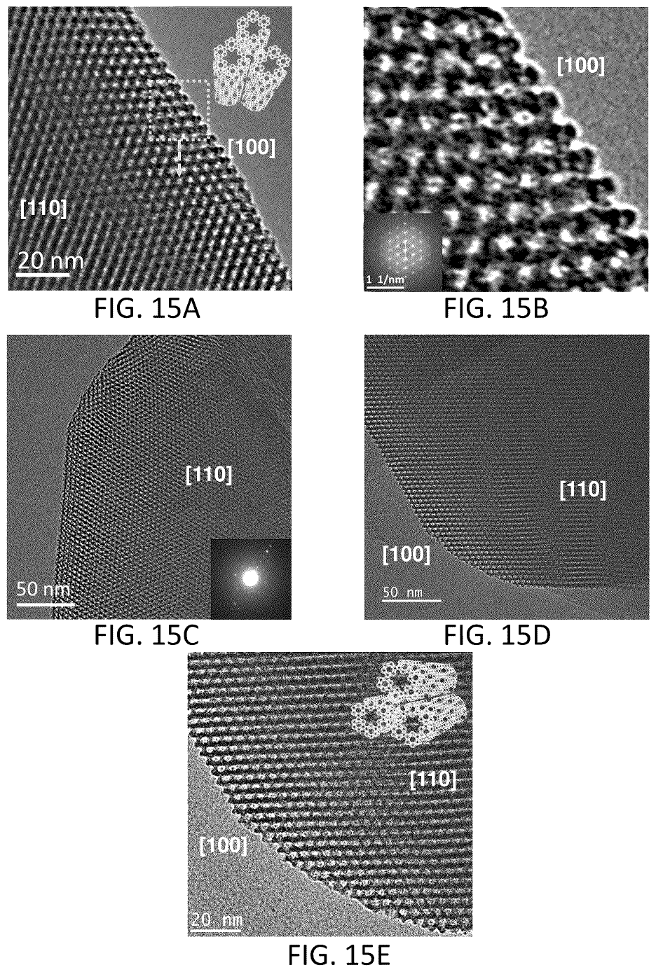

Example 3A: A procedure for synthesis of 2D-hexagonally ordered mesoporous FAU-type zeolites is provided using a sulfate as an ionic co-solute. A quantity of 0.6 grams of urea was added to 10.0 grams of water to form a homogeneous solution. To this solution, a quantity of 1.0 grams of dried zeolite HY-15 was added and stirred for 0.5 hours. Subsequently, 20 milliliters of water, 0.165 grams of ammonium sulfate ((NH₄)₂SO₄) and 1.5 milliliters of DOAC (42.0 wt % in methanol) were added stepwise and the mixture further stirred for 2 hours. The resultant solution was subjected to hydrothermal treatment at 130° C. for 72 hours. The resulting solids were filtered, washed with water, and dried at 120° C. for 24 hours. The synthesized products were calcined in air at 550° C. for 6.0 hours at a ramp rate of 60° C./hour to yield U-S-TMS-a (where S refers to sulfate). The U-S-TMS-a formed in accordance this procedure exhibit 2D-hexagonally ordered mesoporous symmetry, and is characterized in FIGS. 13A-14B, with TEM images presented in FIGS. 15A-E and structural and textural properties provided in Table 3.

Example 3B: A quantity of 1.2 grams of urea was dissolved in 60.0 grams of water to form a homogeneous solution. To this mixture, a quantity of 0.33 grams of ammonium sulfate (NH₄)₂SO₄) was added as a source of ionic co-solute, and stirred until homogeneous. Thereafter a quantity of 2.0 grams of dried zeolite HY-15 was added and stirred for 10 minutes. Subsequently, 3.0 milliliters of DOAC (42.0 wt % in methanol), was added. The resulting solution was stirred for 0.5 hours, followed by hydrothermal treatment at 130° C. for 72 hours. The resulting solids were filtered, washed with water and dried at 120° C. for 24 hours. The synthesized product was calcined in air at 550° C. for 6 hours with a ramp rate of 60° C./hour to yield U-S-TMS-b, which possesses 2D-hexagonally ordered mesoporous symmetry.

The calcined products from Examples 3A-3B are characterized in FIGS. 13A-13D. FIG. 13A depicts low-angle XRD patterns of U-S-TMS-a, FIG. 13B depicts low-angle XRD patterns of U-S-TMS-b, FIG. 13C depicts high-angle XRD patterns of U-S-TMS-a and FIG. 13D depicts high-angle XRD patterns of U-S-TMS-b, with intensity expressed in arbitrary units (a.u.) plotted against frequency 2θ(°). FIGS. 14A and 14C depicts N₂ physisorption isotherms plotting N₂ adsorbed (cm³·g⁻¹) against relative pressure (P/P₀), and FIGS. 14B and 14D depicts non-local density functional theory (NLDFT) pore-size distributions plotting dV/d log W (cm³·g⁻¹), where FIGS. 14A and 14B are related to Example 3A and FIGS. 14C and 14D are related to Example 3B. The high-degree of long-range ordering of calcined U-S-TMS-a and in U-S-TMS-b is apparent from FIGS. 13A and 13B, where low-angle XRD patterns exhibit Bragg's reflection peaks 100, 110 and 200, indicative of 2D-hexagonally ordered mesoporous symmetry. The retention of the underlying zeolite structure is apparent from FIGS. 13C and 13D, where high-angle XRD patterns are consistent with those for the parent zeolite, FAU zeolite.

FIGS. 15A-E presents TEM micrographs of the U-S-TMS-a synthesized in Example 3A, wherein FIG. 15A is an image at a scale of 20 nanometers with a corresponding structural diagram, FIG. 15B is an enlarged view of a portion of the image in FIG. 15A with a fast Fourier transform pattern inset, FIG. 15C is an image at a scale of 50 nanometers showing selected area electron diffraction (SAED) in the inset, FIG. 15D is an image at a scale of 50 nanometers, and FIG. 15E is an image at a scale of 20 nanometers with a corresponding structural diagram.

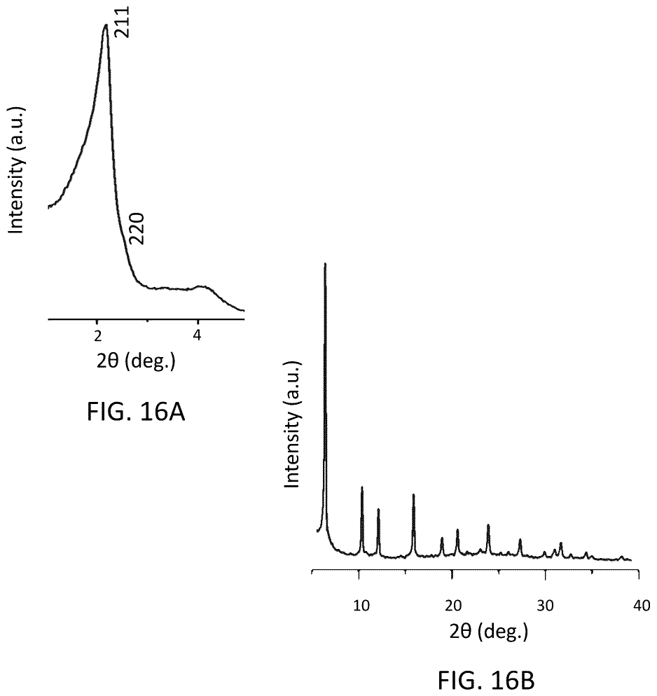

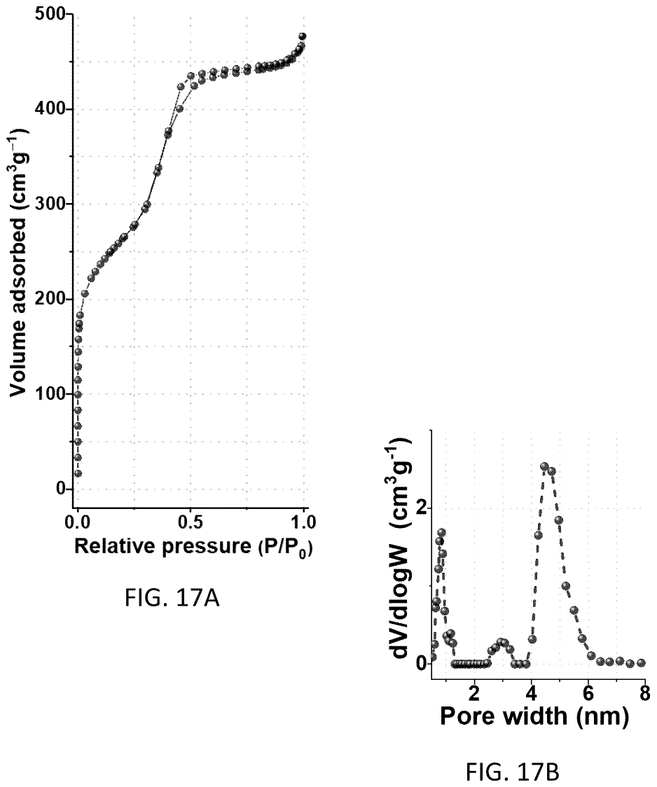

Example 4A: A procedure for synthesis of 3D-cubic ordered mesoporous FAU-type zeolites is provided. A quantity of 2.0 grams of urea was dissolved in 60.0 g of water to form a homogeneous solution. To this mixture, 0.2 g of ammonium nitrate (NH₄NO₃) was added as a source of ionic co-solute, and stirred to form a homogeneous solution. To this mixture, 2.0 g of zeolite HY-15 was added and stirred for 10 minutes. Subsequently, 4.0 milliliters of an organosilane, dimethyloctadecyl(3-trimethoxysilyl-propyl)-ammonium chloride (42.0 wt % in methanol), was added. The resulting solution was stirred for 0.5 hours, followed by hydrothermal treatment at 150° C. for 36 hours. The resulting mixture was filtered, washed with water and dried at 120° C. for 24 hours. The synthesized product was calcined in air at 550° C. for 6 hours with a ramp rate of 60° C./hour to yield U-N-TMS-150-b. The having U-N-TMS-150-b formed in accordance with this procedure exhibits long range 3D cubic mesophase symmetry, and is characterized in FIGS. 16A-17B, and structural and textural properties provided in Table 3. Structural and textural properties of U-N-TMS-150-b are provided in Table 3.

The calcined product from Example 4A is characterized in FIGS. 16A-16B. FIG. 16A depicts low-angle XRD patterns of U-N-TMS-150-b, and FIG. 16B depicts high-angle XRD patterns of U-N-TMS-150-b, with intensity expressed in arbitrary units (a.u.) plotted against frequency 2θ(°). FIG. 17A depicts N₂ physisorption isotherms plotting N₂ adsorbed (cm³·g⁻¹) against relative pressure (P/P₀), and FIG. 17B depicts non-local density functional theory (NLDFT) pore-size distributions plotting dV/d log W (cm³·g⁻¹). The high-degree of long-range ordering of U-N-TMS-150-b is apparent from FIGS. 16A, where low-angle XRD patterns exhibit Bragg's reflection peaks 211 and 220, indicative of 3D cubic mesophase symmetry. The retention of the underlying zeolite structure is apparent from FIG. 16B, where high-angle XRD patterns are consistent with those for the parent zeolite, FAU zeolite.

According to the examples herein, hierarchically ordered FAU-type frameworks exhibiting 2D-hexagonal (p6 mm) and 3D-cubic (Ia-3d) mesopore symmetries are prepared for the first time by a methodical post-synthetic reassembly.

Example 5—Acidity Characterization: Acid site characterization of was carried out by Fourier-transform infrared spectroscopy (FTIR) using a Nicolet 6700 spectrophotometer with pyridine as the probe molecule. Before the analysis, pelletized samples were degassed at 450° C. under vacuum (10-5 mbar) for 24 h. After cooling down to room temperature, the pyridine vapors were dosed for 0.5 h periodically. Subsequently, the physisorbed pyridine was removed under vacuum at 150° C. for 2 h before recording the FTIR spectra. Acid site quantification was done using the following formulae

$${C}_{BAS} = {IMEC}_{BAS}^{- 1} \times {IA}_{BAS} \times π {R}^{2} / W$$

$${C}_{LAS} = {IMEC}_{LAS}^{- 1} \times {IA}_{LAS} \times π {R}^{2} / W$$

where C is the concentration (mol/g zeolite) of acid sites (BAS—Bronsted acid site and LAS—Lewis acid site), IMEC_{BAS}, and IMEC_{LAS} refers to the integrated molar extinction coefficients (BAS—1.67 cm/μmol; LAS—2.22 cm/μmol), IA_{BAS} and IA_{LAS} integrated absorbances (cm⁻¹), R (cm) and W (mg) are the radius and weight of zeolite pellet/disk.

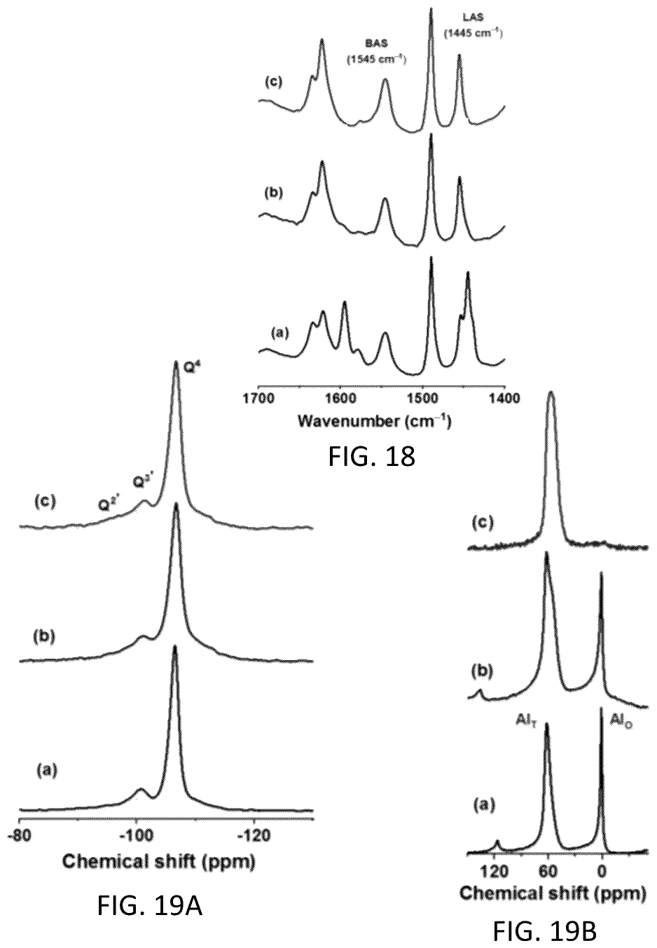

FIG. 18 depicts FTIR spectra of the parent zeolite (a), and hierarchically ordered FAU zeolites herein including the U-N-TMS-150-a (b) and the U-S-TMS-a (c). Bronsted acid cites are indicated at wavenumber 1545 cm⁻¹ and Lewis acid cites are indicated at wavenumber 1445 cm⁻¹.

Table 4 shows acid properties of the parent zeolite (HY-15), and the U-N-TMS-150-a and U-S-TMS-a. The overall acidity of the hierarchically ordered FAU zeolites synthesized is lower compared with the parent zeolite, attributed to the removal of non-framework-Al in the parent zeolite during the reassembly; framework-Al is present as Bronsted acid sites (0.28 mmol/g). The acid sites are reorganized and distributed in the hierarchically ordered FAU zeolites as both new Lewis acid sites (~0.1 mmol/g) and Bronsted acid sites (~0.25 mmol/g). Despite having a lower concentration of zeolitic acid sites compared with the parent zeolite, the hierarchically ordered FAU zeolites synthesized are effective as catalysts supports. The Bronsted/Lewis acid site ratios are higher for the hierarchically ordered FAU zeolites synthesized compared to the parent zeolite.

Table 5 shows the normalized acidity of several zeolites, including a commerical zeolite with a silica-to-alumina ratio of about 40 (comparative zeolite-40), a commerical zeolite with a silica-to-alumina ratio of about 80 (comparative zeolite-80), the U-N-TMS-150-b produced in Example 4A, and the U-S-TMS-b produced in Example 3B. The normalized acidity, in this case, is calculated by multiplying the total acidity (mmol/g) of a zeolite by the normalized mass of the zeolite used in the catalyst formulation (i.e. each zeolite mass divided by 1.321).

Hence, comparative example #2, and both the hierarchical zeolites having cubic and hexagonal long range mesoporous ordering, show a similar normalized acidity, at approx. an 80% reduction in acidity from comparative example #1.

Additionally, although the comparative zeolite-80, U-N-TMS-150-b and U-S-TMS-b zeolites have similar relative acidity, the silica-to-alumina ratios for the U-N-TMS-150-b (cubic—SAR 30.8) and U-S-TMS-b (hexagonal—SAR 31.4) are significantly different than that of the commercial comparative zeolite-80 (SAR 80). Normally, a higher SAR should be expected to offer higher middle distillate yields for an equivalent zeolite loading in the catalyst, since it is the zeolite that is performing the cracking. However, in the case of the cubic and hexagonal zeolites, the middle distillate yields are higher than the commercial comparative zeolite-80 catalyst even though their SARs are lower. This also demonstrates that the nature of the mesopores is impacting the hydrocracking, i.e., the improved long range ordering allows for improved mass transport of components boiling in the middle distillate range to egress out of the system before having chance to undergo secondary cracking to naphtha.

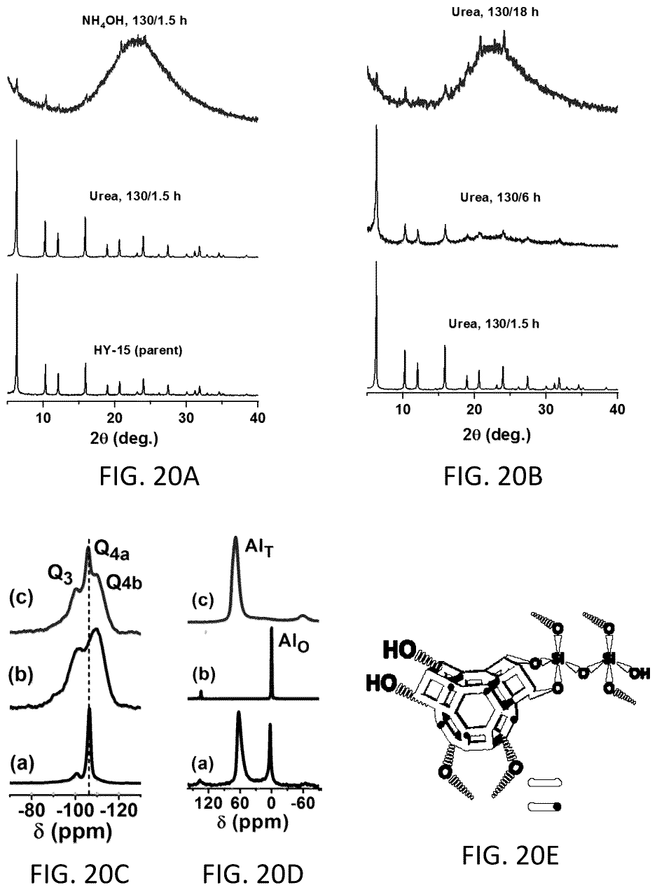

Example 6—Additional characterization: Additional properties of the parent zeolite (a), and hierarchically ordered FAU zeolites herein including the U-N-TMS-150-a (b) and the U-S-TMS-a (c), were determined using ²⁹Si MAS-NMR and ²⁷Al MAS-NMR spectroscopy, shown in FIGS. 19A-B. The ²⁹Si-NMR spectra (FIG. 19A) show two major resonances at ~106 ppm and ~101 ppm corresponding to silicon atoms in 4Si(0Al) and 3Si(1Al) environments, namely Q⁴ and Q^{3′} silica, respectively. The Si/Al ratios calculated from ²⁹Si-NMR spectra (14.8) and inductively coupled plasma analysis (Si/Al ~8.9) revealed that the parent zeolite has nearly 40% of its aluminum as non-framework species in octahedral coordination, which can be seen as a sharp resonance (AlO) at ‘~0 ppm’ in the ²⁷Al-NMR spectra (FIG. 19B). The presence of a high non-framework-Al can be detrimental in catalytic reactions as it causes micropore blockage and alters the product selectivity and coke composition. Conversely, the hierarchically ordered FAU zeolites characterized herein exhibit a higher concentration of framework-Al atoms in the tetrahedral coordination (Al_{T}) as seen by a broad resonance at ‘~60 ppm’. In particular, the U-N-TMS-130-a pattern (b) exhibits ‘Al’ atoms predominantly in the Td coordination. Without wishing to be bound by theory it is expected that this is due to exhaustive dealumination at high synthesis temperatures. Without wishing to be bound by theory the broadness of the Al_{T} resonance associated with the HOZ materials can be ascribed to slight changes in the Al—O bond lengths due to renewed periodicity, aluminum distribution, and crystallite size of the zeolite frameworks.

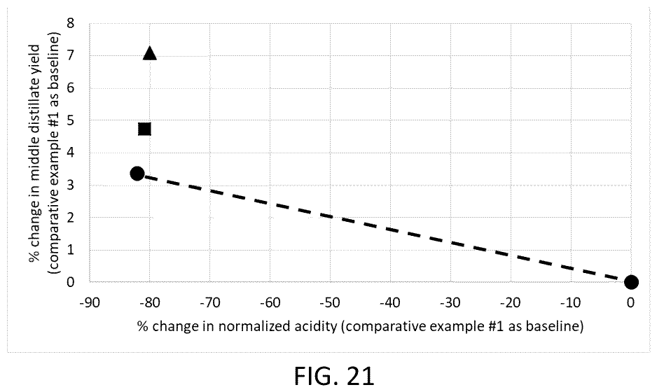

Example 7—Base-mediated dissolution/incision: Base-mediated dissolution studies of the parent zeolite were performed at 130° C. in the absence of a surfactant to interpret the nature of the hierarchical ordering by post-synthetic ensembles process to promote reorganization at the unit-cell level. FIGS. 20A and 20B depict high-angle XRD patterns of the parent zeolite in various stages of treatment. In FIG. 20A, the patterns are the parent zeolite, and after treatment at 130° C. for 1.5 hours with NH₄OH and urea, FIG. 20B depicts the parent zeolite treated with urea at 130° C. after 1.5 hours, 6 hours and 18 hours. FIG. 20C depicts ²⁹Si MAS-NMR and FIG. 20D depicts ²⁷Al MAS-NMR spectra of (a) HY-15; (b) after NH₄OH treatment at 130° C./1.5 h; (c) after urea-treatment at 130° C./6 h. The high-angle XRD studies (FIGS. 20A-B) reveal that, while NH₄OH almost dissolves the zeolite to amorphous frameworks in 1.5 h, urea treatment resulted in partial dissolution even after 6 h. The ²⁷Al- and ²⁹Si-magic angle spinning-nuclear magnetic resonance (MAS-NMR) spectra (FIGS. 20C-D) suggest that the urea treatment selectively dissolves Si—O—Si bonds without strongly affecting the ‘Si—O—Al’ regions and thus the majority of the aluminum is still inside the framework in tetrahedral coordination (Al_{T}~60 ppm). Such dissolution patterns can result in oligomeric zeolitic fragments (Q^{4a}, Q^{3′}, Al_{T}) with siloxane (Q^{4b}) or silanol extensions (Q³), which can be readily reorganized into crystalline mesostructures during thermal treatments. The formation of such zeolite fragments (FIG. 20E) is a factor in the hierarchical ordering by post-synthetic ensembles process to fabricate hierarchically ordered FAU zeolites. Without wishing to be bound by theory it is expected that, in the presence of surfactants, the quantity of Q^{4b} and Q³ species can be significantly fewer due to the surfactant-zeolite interactions that restrict over-dissolution.

In the case of base-mediated reassembly, zeolite dissolution can result in partially crystalline oligomers, which can be recrystallized during hydrothermal (synthesis) and thermal treatments (calcination). However, an uncontrolled dissolution can result in isolated amorphous domains, which fail to recrystallize due to the absence of suitable conditions (high alkalinity and inorganic cations). Therefore, a high concentration of strong bases such as NaOH and NH₄OH can result in uncontrolled dissolution to form amorphous components causing pore-blockage and a concentration gradient across the zeolite crystals. Low base concentrations can lead to insufficient zeolite dissolution due to the decrease in the base concentration with time. As a result, strategically controlling the zeolite dissolution is a factor to enable reassembly into crystalline mesostructures in the syntheses processes herein for hierarchically ordered FAU zeolites.

Example 8—Catalyst formulation 1: Catalysts were prepared by mixing a large pore alumina (PURALOX, SASOL), zeolite, molybdenum trioxide (MoO₃) and nickel(II) nitrate hexahydrate (Ni(NO₃)₂·6H₂O) until homogeneous. Thereafter, an activated alumina binder (CATAPAL B, SASOL) was added and mixed until homogeneous. A nominal amount of distilled water was added to form a dry paste. The mixture was extruded and the extrudates were dried overnight at 150° C. Thereafter, the extrudates were calcined at 550° C. for 6 hrs (ramp rate 2° C./min).

The composition of the cubic (U-N-TMS-150-b), hexagonal (U-S-TMS-b) and comparative zeolite-80 catalyst was MoO₃ (20 wt. %), NiO (5 wt. %), large pore alumina (52.5 wt. %), binder (15 wt. %), zeolite (7.5 wt. %). The composition of the commercial comparative zeolite-40 was MoO₃ (17 wt. %), NiO (4 wt. %), large pore alumina (43 wt. %), binder (15 wt. %), zeolite (24 wt. %), where there was an increased amount of zeolite compared to the cubic and hexagonal compostions.

Table 6 shows the properties of a hydrocarbon feed used in a hydrocracking system used for testing Catalyst formulation 1. The hydrocarbon feed was spiked with ~1000 ppm cyclohexylamine. This was to lower the activity of the catalysts mimicking a 1st stage hydrocracker configuration whereby ammonia formation may not be removed from the system, and thus, the ammonia passivates the acid sites on the zeolite.

A 2 cc sample of each catalyst (metal oxide form) was separately loaded into their own reactor with silicon carbide to maintain the catalyst within the desired heating zone. The catalysts were activated to the sulfide form by way of a DMDS-spiked diesel. After stabilization, the temperature of each reactor was set to meet a target conversion of the feed under the following properties: at a pressure of 147 bar; at an LHSV of 1.8 hr⁻¹; and at a hydrogen-to-oil ratio of 1147 NL/L. The cut-point for the product fractions was 371° C., where the fraction boiling above 371° C. was an unconverted fraction, and the fraction boiling in the 185-371° C. range was the middle distillate fraction.

Apparent conversion was calculated and was based on the formula:

$${X}_{app} = [ ( MF ( Hydrocarbons ) - MF ( UCO effluent ) ) / MF ( Hydrocarbons ) ] \times 100$$

where:
Xₐₚₚ is the apparent conversion;
MF(Hydrocarbons) is the mass fraction of hydrocarbons in the feed; and
MF(UCO effluent) is the mass fraction of unconverted oil in the product effluent.

### Middle Distillate Yields

Table 7 shows the results of hydrocracking with three different hydrocracking catalysts (cubic (U-N-TMS-150-b), hexagonal (U-S-TMS-b) and comparative zeolite-80) having an approximately equivalent normalized acidity. When acidity is increased, for example, through increased zeolite content in the formulation or decreased silica-to-alumina ratio (in other words, more Al and thus more acid sites), the expectation would be that the cracking function of the catalyst, which is derived from the zeolite, would be enhanced and therefore, more secondary cracking can take place. This in turn means the middle distillate yield would be reduced with more naphtha formation, since the components boiling in the middle distillate range are further cracked to naphtha. However, the Table 7 shows that for the equivalent normalized acidity, the hierarchical zeolites possessing long range mesoporous ordering (cubic (U-N-TMS-150-b), hexagonal (U-S-TMS-b)) show higher middle distillate yields across different conversion levels compared with the hierarchical mesoporous zeolite not possessing long range mesoporous ordering (comparative zeolite-80). The improved mass transfer allows the middle distillate products to be removed from the system and not under secondary cracking to naphtha.

Additionally, the hierarchical zeolite having long range mesoporous ordering with a cubic symmetry demonstrates higher middle distillate yields over that of the equivalent hydrocracking catalyst comprising the hierarchical zeolite having long range mesoporous ordering with a hexagonal symmetry. The improved mass transport of the cubic arranged pores further promotes diffusion of the products away from the system and suppresses secondary cracking to naphtha.

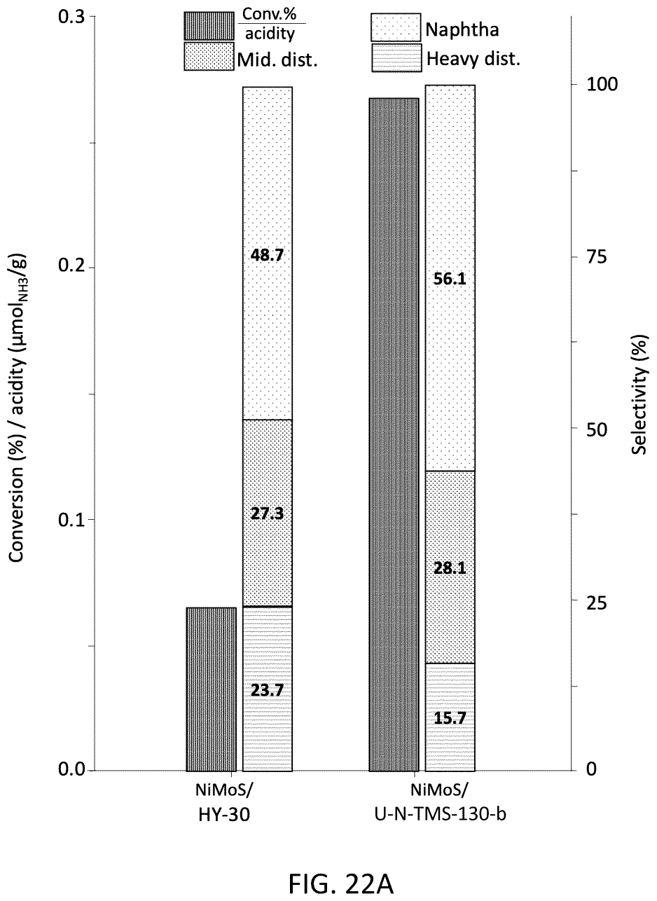

FIG. 21 is a plot of the relative acidity and middle distillate yield (at 50% apparent conversion) compared with comparative zeolite-40 as the baseline for both axes for Catalyst formulation 1. In FIG. 21, the circles represent the commercial FAU zeolites not having long-range mesoporous ordering; the square shows the FAU zeolite possessing hexagonal mesophase; and the triangle shows the FAU zeolite possessing cubic mesophase. The hierarchically ordered FAU zeolites synthesized herein according to Catalyst formulation 1 demonstrates higher conversion and middle distillates selectivity compared with the parent zeolite

Example 9—Catalyst formulation 2: The catalytic properties of the U-N-TMS-130-b 3D-cubic ordered mesoporous FAU-type zeolite were evaluated for the low-pressure hydrocracking of a recycle stream (2nd stage feedstock) from a two-stage hydrocracking unit using a fixed-bed reactor. The feedstock is a pretreated straight-run vacuum gas oil from a first stage hydrocracking unit, and therefore contains very low levels of sulfur and nitrogen, 40 ppmw and 17 ppmw, respectively. The composition and properties of the feedstock are tabulated in Table 8. The catalysts were prepared by mixing the mesoporous FAU-type zeolite (30 wt %) with alumina (70 wt %), followed by incipient wet-impregnation of nickel (Ni) and molybdenum (Mo) species. In particular, 70 wt % alumina was dispersed in a minimum amount of deionized (DI) water. To this slurry, 30 wt % zeolite was added slowly and stirred for 15 min. In the next step, the desired amounts of (NH₄)₆Mo₇O₂₄·4H₂O (8.5 wt % Mo), Ni(NO₃)₂·6H₂O (3.0 wt % Ni) and citric acid (7.5 wt %) were added to the slurry of zeolite-alumina and stirred for another 1 h. The thus obtained mixture was dried at 120° C. overnight, followed by calcination at 550° C. for 4 h. The obtained metal oxide loaded catalysts in powder form were sulfided in a batch reactor (Parr) at 300° C. and 50 bars for 4 h using dimethyldisulfide (1 mL g⁻¹ of catalyst) as a sulfiding agent in the presence of hydrogen at 40 bars. The catalyst bed was prepared by packing 0.5 g of sulfide catalyst between two silicon carbide (46 mesh) layers each (16 ml in volume) in a stainless steel cylindrical reactor (SS316; internal diameter-9.1 mm; length-300 mm) with a 20 μm porous plate located at the bottom. The loaded catalyst was purged with a H₂/N₂ (75:25 volume ratio) gas mixture at a flow rate of 100 ml/h at 450° C. and 50 bars for 2 h to remove any moisture. The catalytic studies were performed at 400° C. temperature and 50 bars pressure with the H2/oil ratio of 750 Nm³/m³ and weight hour space velocity (WHSV) of 1 h⁻¹. The reaction was performed for 10 h, and the liquids were separated from the liquid-gas separator and collected periodically after every hour for gas chromatography (GC) analysis. The liquid products were analyzed according to the ASTM D2887 standard test method using Agilent 6980N GC coupled with simulated distillation (SIMDIS) software.

Additionally, the catalytic properties of the U-S-TMS-b 2D-hexagonally ordered mesoporous FAU-type zeolite were evaluated for the low-pressure hydrocracking of a recycle stream (2nd stage feedstock) from a two-stage hydrocracking unit using a fixed-bed reactor. The feedstock is a pretreated straight-run vacuum gas oil from a first stage hydrocracking unit, and therefore contains very low levels of sulfur and nitrogen, 40 ppmw and 17 ppmw, respectively. The composition and properties of the feedstock used for testing Catalyst formulation 2 are tabulated in Table 8. The catalysts were prepared by mixing the mesoporous FAU-type zeolite (30 wt %) with alumina (70 wt %), followed by incipient wet-impregnation of nickel (Ni) and molybdenum (Mo) species. In particular, 70 wt % alumina was dispersed in a minimum amount of deionized (DI) water. To this slurry, 30 wt % zeolite was added slowly and stirred for 15 min. In the next step, the desired amounts of (NH₄)₆Mo₇O₂₄·4H₂O (8.5 wt % Mo), Ni(NO₃)₂·6H₂O (3.0 wt % Ni) and citric acid (7.5 wt %) were added to the slurry of zeolite-alumina and stirred for another 1 h. The thus obtained mixture was dried at 120° C. overnight, followed by calcination at 550° C. for 4 h. The obtained metal oxide loaded catalysts in powder form were sulfided in a batch reactor (Parr) at 300° C. and 50 bars for 4 h using dimethyldisulfide (1 mL g⁻¹ of catalyst) as a sulfiding agent in the presence of hydrogen at 40 bars. The catalyst bed was prepared by packing 0.5 g of sulfide catalyst between two silicon carbide (46 mesh) layers each (16 ml in volume) in a stainless steel cylindrical reactor (SS316; internal diameter-9.1 mm; length-300 mm) with a 20 μm porous plate located at the bottom. The loaded catalyst was purged with a H₂/N₂ (75:25 volume ratio) gas mixture at a flow rate of 100 ml/h at 450° C. and 50 bars for 2 h to remove any moisture. The catalytic studies were performed at 400° C. temperature and 50 bars pressure with the H2/oil ratio of 750 Nm³/m³ and weight hour space velocity (WHSV) of 1 h⁻¹. The reaction was performed for 10 h, and the liquids were separated from the liquid-gas separator and collected periodically after every hour for gas chromatography (GC) analysis. The liquid products were analyzed according to the ASTM D2887 standard test method using Agilent 6980N GC coupled with simulated distillation (SIMDIS) software.

Conversion (X) of the feed, selectivity (S) and yield (Y) to the hydrocarbon mixtures, naphtha (C4-150° C.), kerosene (150-250° C.), and gas oil (250-370° C.) were calculated from boiling point distribution curves obtained by SIMDIS analysis based on the literature according to equations (1), (2) and (3), respectively:

$$X = ( \frac{R . W {.}_{Feed}^{370 +} - R . W {.}_{Product}^{370 +}}{R . W {.}_{Feed}^{370 +}} ) \times 100 \qquad ( 1 )$$

where

$$R . W {.}_{Feed}^{370 +} and R . W {.}_{Product}^{370 +}$$

correspond to the remaining fraction of material (wt. %) in the feed and product at a boiling point ≥370° C.

$${S}_{x - y} = ( \frac{R . W {.}_{Product}^{x - y} - R . W {.}_{Feed}^{x - y}}{R . W {.}_{Feed}^{370 +} - R . W {.}_{Product}^{370 +}} ) \times 100 \qquad ( 2 )$$

$${Y}_{x - y} = ( \frac{R . W {.}_{Product}^{x - y} - R . W {.}_{Feed}^{x - y}}{R . W {.}_{Feed}^{370 +}} ) \times 100 \qquad ( 3 )$$

where

$$R . W {.}_{Product}^{x - y} and R . W {.}_{Feed}^{x - y}$$

correspond to the fraction of material (wt. %) in the product and the feed between the boiling points ‘x and y’. S_{x-y} and Y_{x-y} correspond to selectivity and yield of the hydrocarbon fractions between boiling points ‘x and y’. Conversion per acid site was calculated by dividing the obtained conversion by the total number of acid sites, which were quantified by pyridine FTIR spectroscopy at 150° C.

Table 9 shows acid properties of the parent zeolite and the synthesized U-N-TMS-130-b and U-S-TMS-b, and catalytic performance of Catalyst formulation 2. Despite having a lower concentration of zeolitic acid sites compared with the parent zeolite, the hierarchically ordered FAU zeolites synthesized herein demonstrates excellent catalytic performance.

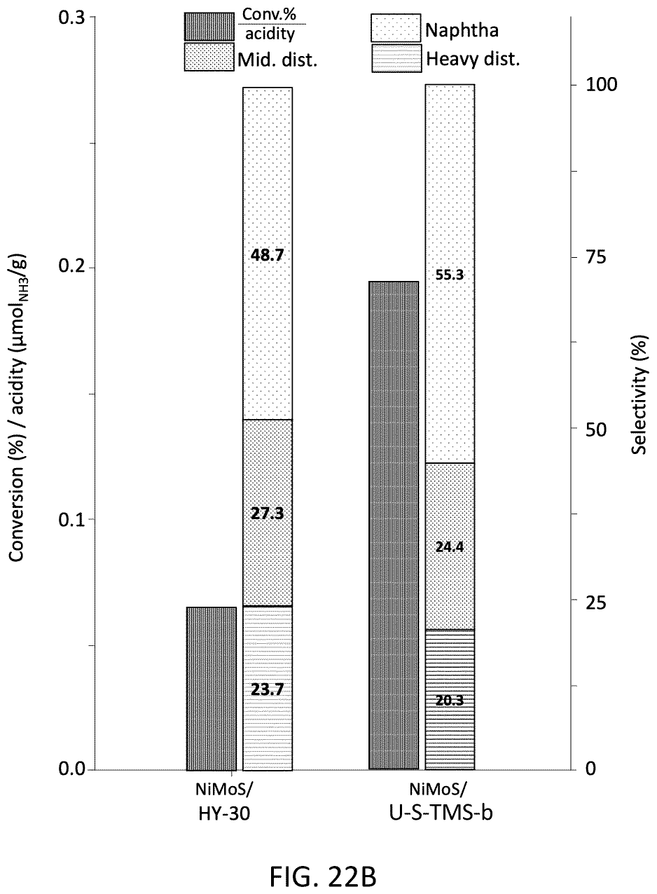

FIGS. 22A and 22B are plots of hydrocracking activity (conversion percentage per acid site) and selectivity (naphtha, middle distillates and heavy distillates) of the catalysts formed using the parent zeolite and the U-N-TMS-130-b and U-S-TMS-b zeolite catalysts described herein for Catalyst formulation 2. The hierarchically ordered FAU zeolites synthesized herein according to Catalyst formulation 2 demonstrates higher conversion and naphtha selectivity compared with the parent zeolite.

Tailoring of the mesophase symmetry, and the associated physicochemical properties that are induced by realizing cubic and hexagonal symmetry mesophase, resulted in increased product selectivity, namely higher middle distillate yields.

As used herein, the phrase “a major portion” with respect to a particular composition and/or solution and/or other parameter means at least about 50% and up to 100% of a unit or quantity. As used herein, the phrase “a significant portion” with respect to a particular composition and/or solution and/or other parameter means at least about 75% and up to 100% of a unit or quantity. As used herein, the phrase “a substantial portion” with respect to a particular composition and/or solution and/or other parameter means at least about 90, 95, 98 or 99% and up to 100% of a unit or quantity. As used herein, the phrase “a minor portion” with respect to a particular composition and/or solution and/or other parameter means at least about 1, 2, 4 or 10%, up to about 20, 30, 40 or 50% of a unit or quantity.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “including,” “comprising,” “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

TABLE 1
Crystal systems.

| System | Unit cell | Essential symmetry of crystal |
|---|---|---|
| Triclinic | No special | None |
| | relationship | |
| Monoclinic | a ≠ b ≠ c | Two-fold axis or mirror plane |
| | α = γ = 90° ≠ β | (inverse two-fold axis) |
| Orthorhombic | a ≠ b ≠ c | Three orthogonal two-fold or |
| | α = β = γ = 90° | inverse two-fold axes |
| Tetragonal | a = b ≠ c | One four-fold or inverse four- |
| | α = β = γ = 90° | fold axis |
| Trigonal | a = b = c | One three-fold axis or inverse |
| | α = β = γ ≠ 90° | three-fold axis |
| Hexagonal | a = b ≠ c | One six-fold or inverse six-fold |
| | α = β = 90°, γ = 120° | axis |
| Cubic | a = b = c | Four three-fold axes |

TABLE 2
Crystal classes

Crystal classes (point group)

| System | Non-centrosymmetric | Centrosymmetric |
|---|---|---|
| Triclinic | 1 | 1̅ |
| Monoclinic | 2, m (=2̅) | 2/m |
| Orthorhombic | 222, 2 mm | mmm |
| Tetragonal | 4, 4̅ | 4/m |
| | 422, 4 mm, 4̅2 m | 4/mmm |
| Trigonal | 3 | 3̅ |
| | 32, 3 m | 3̅ m |
| Hexagonal | 6, 6̅ | 6/m |
| | 622, 6 mm, 6̅2 m | 6/mmm |
| Cubic | 23 | m3̅ |
| | 432, 4̅3 m | m3̅m |

TABLE 3
Structural and textural properties of hierarchical zeolites

| | a₀ ^{Φ} | | | | | | | |
|---|---|---|---|---|---|---|---|---|
| | Micro | Meso | S_{BET} (m² g⁻¹)^{a} | | D | Vₚ (cm³ g⁻¹) ^{d} | | Vₚ − |
| Sample | (Å)^{¢} | (nm) | Micro^{b} | Total | (nm) ^{c} | Micro^{b} | Total | Meso(%)^{e} |
| U-N-TMS- | 24.39 | 10.1^{¢} | 374 | 964 | 4.4 | 0.15 | 0.75 | 80.0 |
| 150-a | | | | | | | | |
| U-N-TMS- | 24.36 | 10.1^{¢} | 430 | 846 | 4.2 | 0.18 | 0.59 | 69.4 |
| 130-a | | | | | | | | |
| U-S-TMS-a | 24.40 | 5.2 | 394 | 834 | 4.4 | 0.16 | 0.48 | 66.6 |
| U-S-TMS-b | 24.40 | 5.2 | 377 | 816 | 4.2 | 0.15 | 0.57 | 73.6 |
| Comparative | 24.28 | — | 640 | 811 | — | 0.25 | 0.44 | 43.2 |
| zeolite | | | | | | | | |
| U-TMS | 24.21 | — | 417 | 874 | — | 0.21 | 0.41 | 48.8 |
| AH-TMS | 24.34 | 5.1 | 207 | 699 | 4.7 | 0.10 | 0.57 | 82.4 |
| AH-CT | 24.37 | — | 275 | 612 | — | 0.11 | 0.49 | 77.5 |
| U-N-TMS- | 24.40 | 10.6 | 287 | 951 | 4.5 | 0.12 | 0.71 | 83.0 |
| 150-b | | | | | | | | |

^{a}Brunauer-Emmett-Teller (BET) surface area;
^{b}calculated using the t-plot method;
^{c} mesopore size;
^{d} pore volume;
^{d} pore volume;
^{e}percentage of mesopore volume.
^{Φ} Unit-cell parameters calculated by formulae−
^{¢}a = d√(h² + k² + l²)

TABLE 4
Acid properties and catalytic activities

| | | BAS | LAS | Total | |
|---|---|---|---|---|---|
| Zeolite | Si/A1ª | (mmol/g) | (mmol/g) | (mmol/g) | B/L^{b} |
| U-N-TMS- | 10.9 | 0.13 | 0.07 | 0.20 | 1.7 |
| 150-a | | | | | |
| U-S-TMS-a | 12.2 | 0.15 | 0.10 | 0.25 | 1.4 |
| Comparative | 14.8 | 0.28 | 0.44 | 0.72 | 0.6 |
| zeolite | | | | | |

^{a}29Si MAS-NMR;
^{b}Brønsted/ Lewis acid ratio

TABLE 5
Normalized Acidity

| | Amount of | | | | % change in |
|---|---|---|---|---|---|
| | zeolite in | | | | normalized |
| | catalyst | Normalized | | | acidity |
| | formulation | zeolite | Total acidity | Normalized | (sample #1 as |
| Zeolite | (g) | amount | (mmol/g) | acidity | baseline) |
| Comparative | 1.321 | 1.000 | 0.375 | 0.375 | 0 |
| zeolite-40 | | | | | |
| Comparative | 0.414 | 0.314 | 0.214 | 0.067 | -82 |
| zeolite-80 | | | | | |
| U-N-TMS- | 0.413 | 0.313 | 0.240 | 0.075 | -80 |
| 150-b | | | | | |
| U-S-TMS-b | 0.413 | 0.313 | 0.230 | 0.072 | -81 |

TABLE 6
Hydrocarbon Feed Properties

| | Units | Value |
|---|---|---|
| Density at 15° C. | g/cc | 0.8805 |
| Sulfur | ppmw | 426 |
| Nitrogen | Ppmw | 26.5 |
| Initial boiling point | ° C. | 93 |
| 5/10 wt. % | ° C. | 303/351 |
| 30/50 wt. % | ° C. | 409/443 |
| 70/90 wt. % | ° C. | 478/527 |
| 95 wt. % | ° C. | 547 |
| Final boiling point | ° C. | 587 |

TABLE 7
Middle Distillate Yields

| | 50% apparent | 60% apparent | 65% apparent |
|---|---|---|---|
| Sample | conversion | conversion | conversion |
| HY-15-80 | 30.7 | 34.0 | 35.5 |
| U-N-TMS-150-b | 31.8 | 36.1 | 38.3 |
| U-S-TMS-b | 31.3 | 35.6 | 37.8 |

TABLE 8
Composition and properties of feedstock

| | |
|---|---|
| Density at 15° C., g/cm³ | 0.8391 |
| Sulfur, ppmw | 40 |
| Nitrogen, ppmw | 17 |
| Initial boiling point, ° C. | 291 |
| 5/10 wt %, ° C. | 353/374 |
| 30/50 wt %, ° C. | 414/441 |
| 70/90 wt %, ° C. | 467/503 |
| 95 wt %, ° C. | 521 |
| Final boiling point, ° C. | 568 |

TABLE 9
Acid properties and catalytic activities*

| | | | | | X_{VGO} | Y (%)^{£} | | |
|---|---|---|---|---|---|---|---|---|
| Zeolite | BAS^{§} | LAS^{¥} | Total | B/L^{¶} | (%)^{¢} | Naphtha | Mid. Dist. | Gas oil |
| U-N-TMS-130-b | 0.13 | 0.07 | 0.20 | 1.7 | 54.6 | 30.6 | 15.3 | 8.7 |
| HY-15 | 0.28 | 0.44 | 0.72 | 0.6 | 46.8 | 22.8 | 12.8 | 11.1 |

*from pyridine FT-IR recorded at 150° C.;
^{§}Brønsted acid sites;
^{¥}Lewis acid sites;
^{¶}Brønsted/Lewis acid ratio;
^{¢}Conversion;
^{£}Yield.
Acidity units are millimoles of adsorbate per gram of zeolite (mmol_{NH3}/g).

1. A hydrocracking method comprising:
contacting a hydrocarbon feed with one or more hierarchically ordered FAU zeolite catalysts, an inorganic oxide, an active metal component, and hydrogen in a hydrocracking reactor to produce a hydrocracked effluent,
wherein the one or more hierarchically ordered FAU zeolite catalysts have a high-degree of long-range mesoporous ordering, and
wherein the one or more hierarchically ordered FAU zeolite catalysts possess a cubic mesophase symmetry or possess a hexagonal mesophase symmetry.

2. The method of claim 1, wherein the long-range mesoporous ordering of the one or more hierarchically ordered FAU zeolite catalysts is defined by the presence of secondary peaks in an X-ray diffraction (XRD) pattern.

3. The method of claim 1, wherein the one or more hierarchically ordered FAU zeolite catalysts have a mesopore periodicity repeating over a length of greater than about 50 nm.

4. The method of claim 2, wherein the one or more hierarchically ordered FAU zeolite catalysts have a mesopore periodicity repeating over a length of greater than about 50 nm.

5. The method of claim 1, wherein the hydrocarbon feed is selected from the group consisting of refined oil obtained from crude oil, synthetic crude oil, bitumen, oil sand, shale oil, and coal oil, and
wherein the hydrocarbon feed has a nitrogen content of less than or equal to 50 ppm and an end boiling point of less than or equal to 833° C.

6. The method of claim 1, wherein the one or more hierarchically ordered FAU zeolite catalysts are passivated.

7. The method of claim 1, wherein hydrocracking reactor operates at
a temperature in the range of from 300° C. to 500° C.,
a hydrogen partial pressure in the range of from 3.5 MPa to 35 MPa,
a hydrogen-to-oil ratio in the range of from 500 N·m/m³ to 2500 N·m/m³, and
a liquid hourly space velocity (LHSV) in the range of from 0.1 hr⁻¹ to 10 hr⁻¹.

8. The method of claim 1, wherein the one or more hierarchically ordered FAU zeolite catalysts has a total acidity in the range of from 0.05-0.5 mmol/g.
